(19) United States
(12) Patent Application Publication
(10) Pub. No.: US 2026/0094354 A1
(43) Pub. Date: Apr. 2, 2026

(54) CONTEXT BASED GAUSSIAN SPLAT RENDERING FOR REPRESENTATIONS

(71) Applicant: Apple Inc., Cupertino, CA (US)

(72) Inventors: Olivier Soares, Oakland, CA (US); Gilles M. Cadet, Agoura Hills, CA (US); Borja Morales Hernando, Sunnyvale, CA (US); Aman Sachan, San Francisco, CA (US); Yan Xiao, Sunnyvale, CA (US); Alan E Chambers, Nederland, CO (US); Arman Uguray, Oakland, CA (US); Edward F Wang, Union City, CA (US); Sebastian P. Herscher, San Francisco, CA (US)

(21) Appl. No.: 19/339,467

(22) Filed: Sep. 25, 2025

Related U.S. Application Data
(60) Provisional application No. 63/700,598, filed on Sep. 27, 2024.
(60) Provisional application No. 63/763,450, filed on Feb. 26, 2025.
(60) Provisional application No. 63/818,865, filed on Jun. 6, 2025.

(51) Int. Cl. G06T 15/20; G06T 15/08; G06V 10/70

(52) U.S. Cl. CPC G06T 15/20; G06T 15/08; G06V 10/768

(57) ABSTRACT

Various implementations disclosed herein include devices, systems, and methods that generate a user representation based on selecting a splat rendering approach. For example, a process may include obtaining representation data of at least a portion of an object. The representation data may include data for multiple sets of splats generated based on a splat generation technique. The process may further include determining a context of a viewing experience. The process may further include selecting a splat rendering approach for use in providing a view that includes a representation of the at least the portion of the object based on the determined context of the viewing experience. The process may further include providing a view of a representation of the at least the portion of the object based on the selected splat rendering approach that includes rendering a subset of splats based on the splat parameter data.

### CROSS-REFERENCE TO RELATED APPLICATIONS

This Application claims the benefit of U.S. Provisional Application Ser. No. 63/818,865 filed Jun. 6, 2025, U.S. Provisional Application Ser. No. 63/763,450 filed Feb. 26, 2025, and U.S. Provisional Application Ser. No. 63/700,598 filed Sep. 27, 2024, each of which are incorporated herein by reference in their entirety.

### TECHNICAL FIELD

The present disclosure generally relates to electronic devices, and in particular, to systems, methods, and devices for representing objects in computer-generated content.

### BACKGROUND

Existing techniques may not accurately or honestly present current (e.g., real-time) representations of the appearances of objects, such as users of electronic devices. For example, a device may provide a representation of a user based on images of the user's face that were obtained minutes, hours, days, or even years before. Such a representation may not accurately represent the user's appearance, for example, not showing a person's hair correctly for a realistic representation. Thus, it may be desirable to provide a means of efficiently providing more accurate, honest, and/or current representations of objects, such as users (e.g., personas).

### SUMMARY

Various implementations disclosed herein include devices, systems, and methods that generate a view of a user representation based on three-dimensional (3D) Gaussian splatting. Gaussian splatting is a technique where individual 3D points are represented as Gaussian distributions (like “splats”) with color values that change depending on the viewing angle, using spherical harmonics to model this view-dependent color variation and enables real-time rendering of high-quality, photorealistic scenes from a sparse set of images. For example, each point has a color that is calculated based on its position relative to the camera, allowing for realistic shading effects across different viewpoints.

In an exemplary implementation, a first set of captured user data (e.g., enrollment data) may be used to generate user representation data including splat parameter data (e.g., a multi-channel Gaussian UV map) at a first device (e.g., a sending device). The view of the user representation may be provided to a viewing device (e.g., rendering a live view of a sender's persona) by generating splats corresponding to modified user representation data. A persona is a representation of a user, like an avatar. Advantageously, splatting avoids the need to use a mesh to avoid the appearance of holes and provides other advantages. The 3D representations of the user at multiple instants in time may be generated on a viewing device that combines the data and uses the combined data to render views, for example, during a live communication (e.g., a virtual communication or a co-presence) session.

In some implementations, to improve rendering efficiency, since not all splats are needed for each frame, multiple sets of splat parameter data may be generated, and one set of splat parameter data may be selected to be rendered based on a context of a viewing experience. In some implementations, the multiple sets of splat parameter data may correspond to different splat models having different number of splats, splat sizes, and/or splat quality (e.g., sets of splat parameter data ranging in different resolutions/sizes from 16 k splats to 64 k splats, and the like).

Additionally, or alternatively, in some implementations, the multiple sets of splat parameter data may correspond to different gaussian based level of details (LODs). The gaussian based LODs may be based on dividing the splats into groups and merging particular groupings and/or a hierarchy of splats based on the 3DGS parameters. In some implementations, the splats are arranged based on a UV mesh or UV space topology in order to divide and combine/merge the static (or less dynamic) splats. In other words, the splats that remain as static as possible during animation (e.g., typically there are no or less changes/movements in shoulder splats for a persona rendering), the system may harness the power of temporal coherence and merge the static splats. In some implementations, identifying regions such as hair splats compared to skin splats as static splats, each group may have different rendering characteristics that are taken into consideration, e.g., hair being a more fine volumetric like structure as opposed to the more opaque subsurface scattering properties of skin. In some implementations, the LODs may avoid merging particular dynamic regions, such as regions that require more detail and/or may move more during animation and rendering. For example, during a communication session, when generating personas in real-time, the mouth regions and/or eye regions may move during the session. Thus, those particular dynamic regions may be avoided when merging the splats.

Additionally, or alternatively, in some implementations, a method may include a process that provides a dynamic, context-based selection and transitioning between LODs for 3DGS rendering, with a focus on minimizing perceptible transition artifacts and optimizing for both distance, gaze, and field of view. For example, systems and methods may provide a dynamic, context-aware rendering of 3D representations using Gaussian splats, with advanced LOD transition merging (e.g., merging of splats during LOD transitions) based on whether the persona is inside or outside of a gaze cone based on a gaze vector (e.g., within the foveal region or in the periphery), which may be determined based on the user's perspective, gaze, and/or the position of the persona relative to the field of view. For example, instead of abrupt LOD switches (e.g., from 64 k to 16 k splats), the system introduces a smooth, continuous reduction of splats. As the viewer moves away from the persona, splats are gradually merged, creating a transition zone that avoids noticeable “popping” effects. This merging may be tuned and may incorporate noise-based selection for further optimization. This approach enables smooth, continuous LOD transitions while merging splats, minimizes visual artifacts, and optimizes rendering efficiency and fidelity in regions of interest.

In some implementations, the analysis of the context of the viewing experience (e.g., during a live communication session) for the selection may determine whether a view of the rendering of the representation is close or far away from a current viewpoint. For example, if the perceived distance of the representation to be rendered is further than a perceived distance threshold (e.g., in the background of a current view), then a lesser quality of a rendering of the representation may be selected (e.g., 32 k splats or a LOD that has been divided and merged in groups, or at least partially merged based on identified static splats). On the other hand, if the perceived distance of the representation to be rendered is closer than a perceived distance threshold (e.g., a user representation (persona) during a communication session), then a higher quality of a rendering of the representation may be selected (e.g., 64 k splats or a LOD that has not been divided/merged). Additionally, a determined context of a viewing experience may indicate that the viewer is taking a picture or recording a video of the viewing experience, thus it would be desirable to render a higher quality representation.

In some implementations, data associated with each splat of a user representation may represent a texture/color, a 3D position, direction and angle information (e.g., cone of visibility), a splat shape, a level of transparency, a covariance (e.g., how a splat is stretched/scaled), and the like. The splats may be a 3D Gaussian distribution in a two-dimensional (2D) space with color/density (e.g., parameterization), where a person's face may be utilized as a grid, and a number of splats may be determined based on a ray off the face/grid. The grid/parameterization of the splat distribution provides higher quality data, may be faster to train a machine learning model, and may provide faster (e.g., real-time) rasterization. In some implementations, 3D mapping information (e.g., identifying x, y, z positions corresponding to UV coordinates of a UV map) may be generated at enrollment (e.g., Gaussian UV maps).

In general, one innovative aspect of the subject matter described in this specification can be embodied in methods that include the actions of, at a processor of a device, obtaining representation data representing at least a portion of an object, wherein the representation data includes data for multiple sets of splats generated based on a splat generation technique, the data for each set of the multiple sets of splats including three-dimensional (3D) Gaussian data. The actions further include determining a context of a viewing experience. The actions further include selecting a splat rendering approach for use in providing a view that includes a representation of the at least the portion of the object based on the determined context of the viewing experience. The actions further include providing a view of a representation of the at least the portion of the object based on the selected splat rendering approach, wherein providing the view includes rendering a subset of splats based on the splat parameter data.

These and other embodiments can each optionally include one or more of the following features.

In some aspects, the at least the portion of the object includes a face portion and an additional portion of a user. In some aspects, the representation data is based on 3D point cloud points associated with distribution data defining sizes and shapes for rendering the 3D point cloud points as splats. In some aspects, the 3D Gaussian data includes 3D Gaussian parameters. In some aspects, the 3D Gaussian parameters includes at least one of position information, color information, covariance information, transparency information, an orientation, opacity information, extent information in each axis, rotation data, a scale, and semantic information.

In some aspects, the splat generation technique includes a splat criterion associated with a resolution of each splat associated with each of the multiple sets of splats. In some aspects, the splat generation technique includes a splat criterion associated with a quantity of splats associated with each of the multiple sets of splats. In some aspects, the splat generation technique includes a splat criterion associated with a size of each splat associated with each of the multiple sets of splats.

In some aspects, selecting the splat rendering approach includes selecting between a first approach that renders a first set of the multiple sets of splats and a second approach that renders a second set of the multiple sets of splats, wherein the first set of multiple sets of splats has more splats than the second set of the multiple sets of splats.

In some aspects, each of the multiple sets of splats are based on a different level of detail (LOD). In some aspects, the splat generation technique includes a splat criterion associated with merging a plurality of subsets of splats based on the splat parameter data. In some aspects, the plurality of subsets of splats are selected based on determining one or more static regions associated with representing the at least the portion of the object. In some aspects, the merging of the plurality of subsets of splats is determined during an enrollment process.

In some aspects, selecting the splat rendering approach includes selecting an approach that reduced a level of rendering detail by switching to rendering a lower level-of-detail (LOD) representation, rendering the lower LOD representation including merging a subset of splats in a transition zone based on a position at which the at least the portion of the object is to be depicted within a 3D environment.

In some aspects, during the merging of the subset of splats in the transition zone, a number of rendered splats is reduced as a distance associated with the position at which the at least the portion of the object is to be depicted increases. In some aspects, the merging of the subset of splats is performed in groups, with each group corresponding to a range of distances associated with the position at which the at least the portion of the object is to be depicted.

In some aspects, the merging of splats is based on determining whether a viewpoint characteristic satisfies a criterion, wherein the viewpoint characteristic is determined based on a viewpoint and a position at which the at least the portion of the object is to be depicted within a 3D environment. In some aspects, the criterion is based on a threshold angular distance from a gaze direction. In some aspects, the criterion is based on a threshold distance associated with the position at which the at least the portion of the object is to be depicted within the 3D environment.

In some aspects, the merging of splats in peripheral regions is performed using a sparse UV mapping technique. In some aspects, the selection of splats to merge is based at least in part on a noise function. In some aspects, a number of splats rendered for providing the view of the representation of the at least the portion of the object is adjusted between a minimum and a maximum value as a function of at least one of: a distance associated with how the at least the portion of the object is to be depicted within the viewing experience, a gaze, or a field of view.

In some aspects, the context of the viewing experience includes a viewpoint of the view of the representation and selecting the splat rendering approach for use in providing a view is based on a threshold distance associated with the viewpoint. In some aspects, the context of the viewing experience includes recording of at least one frame of content associated with a viewpoint of the view of the representation and selecting the splat rendering approach for use in providing a view is based on the recording of the at least one frame of content.

In some aspects, the view of the representation is provided for a first frame of a plurality of frames for a first viewpoint, the method further including, for a second viewpoint for a second frame of the plurality of frames: determining that the second viewpoint is equivalent to the first viewpoint; and reusing the view of the representation of the at least the portion of the object from the first frame for the second frame.

In some aspects, the view of the representation is provided for a first frame of a plurality of frames for a first viewpoint, the method further including, for a second viewpoint for a second frame of the plurality of frames: determining that the second viewpoint is different than the first viewpoint; selecting an additional set of the multiple sets of splats based on a context of a viewing experience associated with the second frame; updating the view of the representation of the at least the portion of the object based on the selected additional set of the multiple sets of splats.

In some aspects, the device is a viewer's device, wherein the splat rendering approach for use in providing the view is selected based on data obtained during a communication session with a sender's device associated with the representation of the at least the portion of the object. In some aspects, the representation data is generated and updated during an enrollment process based on images of a face of a user captured while the user is expressing a plurality of different facial expressions.

In some aspects, the splat generation technique generates the representation data via a machine learning model trained using training data obtained via one or more sensors in one or more environments. In some aspects, providing the view of the representation of the at least the portion of the object based on the selected splat rendering approach includes displaying the representation in an extended reality (XR) environment.

In some aspects, the representation data is obtained in a first physical environment, and the representation is displayed in a view of a second physical environment that is different than the first physical environment. In some aspects, the representations is a 3D representation.

In general, another innovative aspect of the subject matter described in this specification can be embodied in methods that include the actions of, at a processor of a device, obtaining representation data representing at least a portion of an object, wherein the representation data includes Gaussian data for rendering multiple splats for a first set of three-dimensional (3D) points to represent a 3D appearance of the object. The actions further include determining a viewpoint characteristic based on a viewpoint and a position at which the at least the portion of the object is to be depicted within a 3D environment. The actions further include based on the viewpoint characteristic satisfying a criterion, generating modified representation data for a region by merging subsets of the representation data to represent a second set of 3D points, wherein the second set of 3D points is fewer in number than the first set of 3D points. The actions further include providing a view of a representation of the at least the portion of the object by rendering splats based on the modified representation data.

These and other embodiments can each optionally include one or more of the following features.

In some aspects, during the merging of the subsets of the representation data to represent a second set of 3D points, a number of rendered splats is reduced as a distance associated with the position at which the at least the portion of the object is to be depicted increases. In some aspects, the merging of the subsets of the representation data to represent a second set of 3D points is performed in groups, with each group corresponding to a range of distances associated with the position at which the at least the portion of the object is to be depicted. In some aspects, the merging of the subsets of the representation data to represent a second set of 3D points is based on determining whether a viewpoint characteristic satisfies the criterion, wherein the viewpoint characteristic is determined based on the viewpoint and the position at which the at least the portion of the object is to be depicted within a 3D environment.

In some aspects, the criterion is based on a threshold angular distance from a gaze direction. In some aspects, the criterion is based on a threshold distance associated with the position at which the at least the portion of the object is to be depicted within the 3D environment.

In some aspects, the merging of the subsets of the representation data to represent a second set of 3D points in peripheral regions is performed using a sparse UV mapping technique. In some aspects, a selection of the subsets of the representation data to merge is determined based at least in part on a noise function. In some aspects, a number of splats rendered for providing the view of the representation of the at least the portion of the object is adjusted between a minimum and a maximum value as a function of at least one of: a distance associated with how the at least the portion of the object is to be depicted within the viewing experience, a gaze, or a field of view. In some aspects, the at least the portion of the object includes a face portion and an additional portion of a user.

In some aspects, the representation data is based on 3D point cloud points associated with distribution data defining sizes and shapes for rendering the 3D point cloud points as splats. In some aspects, the Gaussian data includes 3D Gaussian parameters. In some aspects, the Gaussian parameters include at least one of position information, color information, covariance information, transparency information, an orientation, opacity information, extent information in each axis, rotation data, a scale, and semantic information.

In accordance with some implementations, a non-transitory computer readable storage medium has stored therein instructions that are computer-executable to perform or cause performance of any of the methods described herein. In accordance with some implementations, a device includes one or more processors, a non-transitory memory, and one or more programs; the one or more programs are stored in the non-transitory memory and configured to be executed by the one or more processors and the one or more programs include instructions for performing or causing performance of any of the methods described herein.

### BRIEF DESCRIPTION OF THE DRAWINGS

So that the present disclosure can be understood by those of ordinary skill in the art, a more detailed description may be had by reference to aspects of some illustrative implementations, some of which are shown in the accompanying drawings.

FIG. 1 illustrates a device obtaining sensor data from a user according to some implementations.

FIG. 2 illustrates exemplary electronic devices operating in different physical environments during a communication session of a first user at a first device and a second user at a second device with a view of a combined three-dimensional (3D) representation of the second user for the first device in accordance with some implementations.

FIG. 3A-3D illustrate examples of 3D Gaussian splats (3DGS) for use with generating views of 3D representations in accordance with some implementations.

FIG. 4 illustrates an example of generating and displaying a stereo view of splats on a device in accordance with some implementations.

FIG. 5 illustrates an example of generating multiple sets of splats based on different level of details (LODs) by merging groups of splats using 3DGS parameters in accordance with some implementations.

FIG. 6 illustrates an example of generating a representation of a user by rendering splat parameter data using a selected splat rendering approach based on a context of a viewing experience in accordance with some implementations.

FIG. 7 illustrates exemplary electronic devices operating in different physical environments during a communication session with multiple users and includes a view of 3D representations of other users using a selected splat rendering approach in accordance with some implementations.

FIG. 8 illustrates an example gaze cone and a view of a 3D environment that includes different personas provided by a device of FIG. 1, in accordance with some implementations.

FIG. 9 illustrates different regions of the example gaze cone of FIG. 8 based on viewpoint characteristics, in accordance with some implementations.

FIG. 10A-10C illustrate different examples of rendering a persona in a 3D environment using different level of details based on viewpoint characteristics in accordance with some implementations.

FIG. 11 is a flowchart representation of a method for providing a view of a representation by rendering splat parameter data using a selected splat rendering approach based on a context of a viewing experience, in accordance with some implementations.

FIG. 12 is a flowchart representation of a method for providing a view of a representation by rendering splats based on merging subsets of representation data, in accordance with some implementations.

FIG. 13 is a block diagram illustrating device components of an exemplary device according to some implementations.

FIG. 14 is a block diagram of an example head-mounted device (HMD) in accordance with some implementations.

In accordance with common practice the various features illustrated in the drawings may not be drawn to scale. Accordingly, the dimensions of the various features may be arbitrarily expanded or reduced for clarity. In addition, some of the drawings may not depict all of the components of a given system, method or device. Finally, like reference numerals may be used to denote like features throughout the specification and figures.

### DESCRIPTION

Numerous details are described in order to provide a thorough understanding of the example implementations shown in the drawings. However, the drawings merely show some example aspects of the present disclosure and are therefore not to be considered limiting. Those of ordinary skill in the art will appreciate that other effective aspects or variants do not include all of the specific details described herein. Moreover, well-known systems, methods, components, devices and circuits have not been described in exhaustive detail so as not to obscure more pertinent aspects of the example implementations described herein.

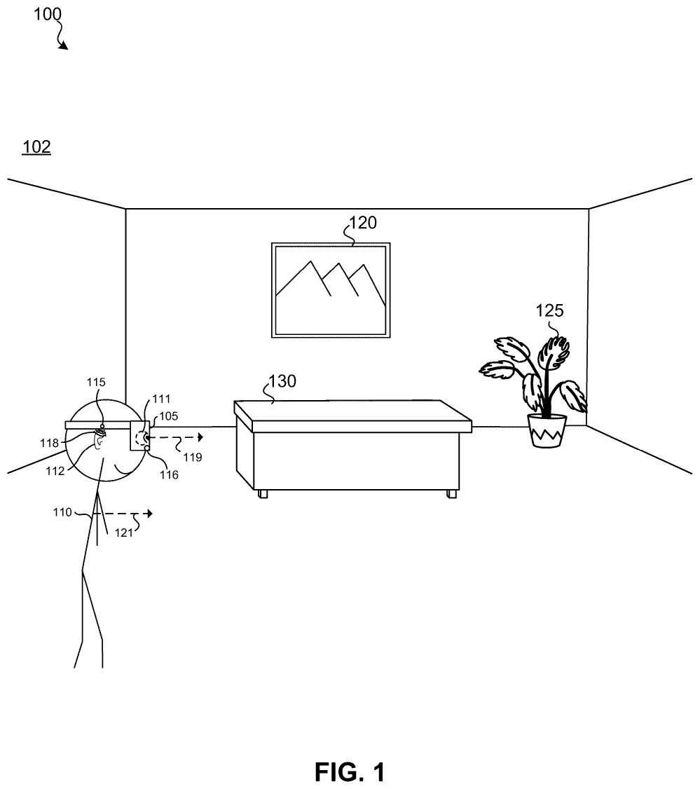

FIG. 1 illustrates an example environment 100 of exemplary electronic device 105, operating in a physical environment 102. In some implementations, electronic device 105 may be able to share information with another device or with an intermediary device, such as an information system. Additionally, physical environment 102 includes user 110 wearing device 105. In some implementations, the device 105 is configured to present views of an extended reality (XR) environment, which may be based on the physical environment 102, and/or include added content such as virtual elements.

In the example of FIG. 1, the physical environment 102 is a room that includes physical objects such as wall hanging 120, plant 125, and desk 130. The electronic device 105 may include one or more cameras, microphones, depth sensors, motion sensors, or other sensors that can be used to capture information about and evaluate the physical environment 102 and the objects within it, as well as information about user 110.

In the example of FIG. 1, the device 105 includes one or more sensors 116 that capture light-intensity images, depth sensor images, audio data or other information about the user 110 (e.g., internally facing sensors and externally facing cameras). For example, the one or more sensors 116 may capture images of the user's (e.g., user 110) forehead, eyebrows, eyes, eye lids, cheeks, nose, lips, chin, face, head, hands, wrists, arms, shoulders, torso, legs, or other body portion. For example, internally facing sensors may see what's inside of the device 105 (e.g., the user's eyes and around the eye area), and other external cameras may capture the user's face outside of the device 105 (e.g., egocentric cameras that point toward the user 110 outside of the device 105). Sensor data about a user's eye 111, as one example, may be indicative of various user characteristics, e.g., the user's gaze direction 119 over time, user saccadic behavior over time, user eye dilation behavior over time, etc. The one or more sensors 116 may capture audio information including the user's speech and other user-made sounds as well as sounds within the physical environment 100.

In some implementations, the device 105 includes an eye tracking system for detecting eye position and eye movements via eye gaze characteristic data. For example, an eye tracking system may include one or more infrared (IR) light-emitting diodes (LEDs), an eye tracking camera (e.g., near-IR (NIR) camera), and an illumination source (e.g., an NIR light source) that emits light (e.g., NIR light) towards the eyes of the user 110. Moreover, the illumination source of the device 105 may emit NIR light to illuminate the eyes of the user 110 and the NIR camera may capture images of the eyes of the user 110. In some implementations, images captured by the eye tracking system may be analyzed to detect position and movements of the eyes of the user 110, or to detect other information about the eyes such as color, shape, state (e.g., wide open, squinting, etc.), pupil dilation, or pupil diameter. Moreover, the point of gaze estimated from the eye tracking images may enable gaze-based interaction with content shown on the near-eye display of the device 105.

Additionally, the one or more sensors 116 may capture images of the physical environment 100 (e.g., externally facing sensors). For example, the one or more sensors 116 may capture images of the physical environment 100 that includes physical objects such as wall hanging 120, plant 125, and desk 130. Moreover, the one or more sensors 116 may capture images (e.g., light intensity images and/or depth data).

One or more sensors, such as one or more sensors 115 on device 105, may identify user information based on proximity or contact with a portion of the user 110. As example, the one or more sensors 115 may capture sensor data that may provide biological information relating to a user's cardiovascular state (e.g., pulse), body temperature, breathing rate, etc.

The one or more sensors 116 or the one or more sensors 115 may capture data from which a user orientation 121 within the physical environment can be determined. In this example, the user orientation 121 corresponds to a direction that a torso of the user 110 is facing.

Some implementations disclosed herein determine a user understanding or a scene understanding based on sensor data obtained by a user worn device, such as first device 105. Such a user understanding may be indicative of a user state that is associated with providing user assistance or facilitating a communication session. In some example, a user's appearance or behavior or an understanding of the environment (scene understanding) may be used to recognize a need or desire for assistance so that such assistance can be made available to the user. For example, based on determining such a scene understanding, augmentations may be provided to assist the user by enhancing or supplementing the user's abilities, e.g., information about an environment to a person. Additionally, a user understanding and/or a scene understanding may be utilized to customize a viewing experience, e.g., selecting a rendering mode, which will be further discussed herein.

Content may be visible, e.g., displayed on a display of device 105, or audible, e.g., produced as audio 118 by a speaker of device 105. In the case of audio content, the audio 118 may be produced in a manner such that only user 110 is likely to hear the audio 118, e.g., via a speaker proximate the ear 112 of the user or at a volume below a threshold such that nearby persons are unlikely to hear. In some implementations, the audio mode (e.g., volume), is determined based on determining whether other persons are within a threshold distance or based on how close other persons are with respect to the user 110.

In some implementations, the content provided by the device 105 and sensor features of device 105 may be provided using components, sensors, or software modules that are sufficiently small in size and efficient with respect to power consumption and usage to fit and otherwise be used in lightweight, battery-powered, wearable products such as wireless ear buds or other ear-mounted devices or head mounted devices (HMDs) such as smart/augmented reality (AR) glasses. Features can be facilitated using a combination of multiple devices. For example, a smart phone (connected wirelessly and interoperating with wearable device(s)) may provide computational resources, connections to cloud or internet services, location services, etc.

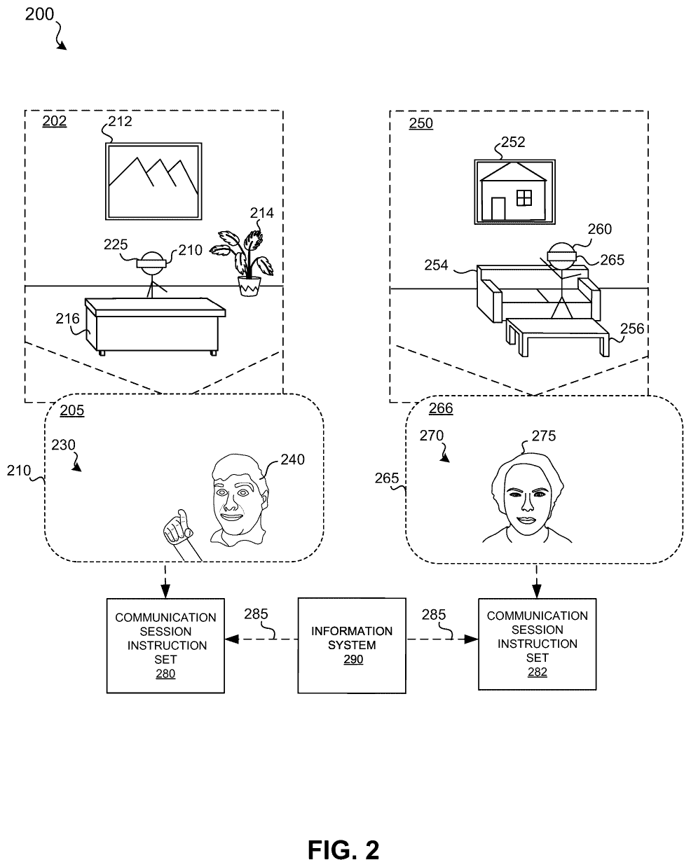

FIG. 2 illustrates exemplary electronic devices operating in different physical environments during a communication session of a first user at a first device and a second user at a second device. In particular, FIG. 2 illustrates exemplary operating environment 200 of electronic devices 210, 265 operating in different physical environments 202, 250, respectively, during a communication session, e.g., while the electronic devices 210, 265 are sharing information with one another or an intermediary device such as a communication session system/server. In this example of FIG. 2, the physical environment 202 is a room that includes a wall hanging 212, a plant 214, and a desk 216 (e.g., physical environment 102 of FIG. 1). The electronic device 210 includes one or more cameras, microphones, depth sensors, or other sensors that can be used to capture information about and evaluate the physical environment 202 and the objects within it, as well as information about the user 225 of the electronic device 210. The information about the physical environment 202 and/or user 225 may be used to provide visual content (e.g., for user representations) and audio content (e.g., for audible voice or text transcription) during the communication session.

Additionally, in this example of FIG. 2, the physical environment 250 is a room that includes a wall hanging 252, a sofa 254, and a coffee table 256. The electronic device 265 includes one or more cameras, microphones, depth sensors, or other sensors that can be used to capture information about and evaluate the physical environment 250 and the objects within it, as well as information about the user 260 of the electronic device 265 (e.g., a user worn device or HMD device, such as device 105). The information about the physical environment 250 and/or user 260 may be used to provide visual and audio content during the communication session.

The information system 290 may orchestrate the sharing of assets (e.g., data associated with user representations) between two or more devices (e.g., electronic devices 210 and 265) using communication instruction set 280 and communication instruction set 282.

FIG. 2 illustrates an example of a view 205 provided at device 210, where the view 205 depicts a 3D environment 230 by providing passthrough video of physical environment 202 augmented with a user representation 240 (e.g., a persona) of at least a portion of user 260. The provision/inclusion of the user representation 240 may be based on there being consent from user 260. In particular, the user representation 240 of user 260 is generated based on one or more user representation techniques. The generation of user representations is further discussed herein.

FIG. 2 illustrates an example of a view 266 provided at device 265 where the view depicts a 3D environment 270 by providing passthrough video of physical environment 250 augmented with a user representation 275 (e.g., a persona) of at least a portion of the user 225 (e.g., from mid-torso up). The provision/inclusion of the user representation 275 may be based on there being consent from user 225. The user representations 240, 275 may be generated at either device based on sensor data obtained at one of the respective devices 210, 265. In some embodiments, each of the 3D representations 240 of user 260 and 275 of user 225 is generated by generating splats corresponding to user representation data.

In the example of FIG. 2, the electronic devices 210, 265 are illustrated as a head-mounted devices (HMDs). However, either of the electronic devices 210, 265 may be a mobile phone, a tablet, a laptop, or any other form of wearable device (e.g., head-worn device (glasses), headphones, an ear mounted device, and so forth). In some implementations, functions of each of the devices 210 and 265 are accomplished via two or more devices, for example a mobile device and base station or a head mounted device and an ear mounted device. Various capabilities may be distributed amongst multiple devices, including, but not limited to power capabilities, CPU capabilities, GPU capabilities, storage capabilities, memory capabilities, visual content display capabilities, audio content production capabilities, and the like. The multiple devices that may be used to accomplish the functions of electronic devices 210 and 265 may communicate with one another via wired or wireless communications. In some implementations, each device communicates with a separate controller or server to manage and coordinate an experience for the user (e.g., a communication session server). Such a controller or server may be located within or may be remote relative to the physical environment 202 and/or physical environment 250.

Additionally, in the example of FIG. 2, the 3D environments 230 and 270 may correspond to the respective viewing user's physical environment (e.g., where the views show passthrough video) or may be a common environment corresponding to just one of the physical environments 202, 250 or another real or virtual environment. The 3D environments may be based on a common coordinate system that can be shared amongst users (e.g., providing a virtual room for personas for a multi-person communication session). In other words, a common coordinate system may be used for the 3D environments 230 and 270. A common reference point may be used to align the coordinate systems. In some implementations, the common reference point may be a virtual object within the 3D environment that each user can visualize within their respective views. For example, a common center piece table that the user representations (e.g., the user's personas) are positioned around within the 3D environment. Alternatively, the common reference point is not visible within each view. For example, a common coordinate system of a 3D environment may use a common reference point for positioning each respective user representation (e.g., around a table/desk). Thus, if the common reference point is visible, then each view of the device would be able to visualize the “center” of the 3D environment for perspective when viewing other user representations. The visualization of the common reference point may become more relevant with a multi-user communication session such that each user's view can add perspective to the location of each other user during the communication session.

In some implementations, the representations of each user may be realistic or unrealistic and/or may represent a current and/or prior appearance of a user. For example, a photorealistic representation of the user 225 or 260 may be generated based on a combination of live images and prior images of the user. The prior images may be used to generate portions of the representation for which live image data is not available (e.g., portions of a user's face that are not in view of a camera or sensor of the electronic device 210 or 265 or that may be obscured by the respective device and/or occluded, for example, by a hand of the user). In one example, the electronic devices 210 and 265 are HMDs and live image data of the user's face includes a downward facing camera that obtains images of the user's cheeks and mouth and inward facing camera images of the user's eyes, which may be combined with prior image data of the user's other portions of the user's face, head, and torso that cannot be currently observed from the sensors of the device. Prior data regarding a user's appearance may be obtained at an earlier time during the communication session, during a prior use of the electronic device, during an enrollment process used to obtain sensor data of the user's appearance from multiple perspectives and/or conditions, or otherwise.

In some implementations, generating views of one or more user representations for a communication session as illustrated in FIG. 2 (e.g., generating user representation 240, 275), may be based on one more rendering techniques, such as using a 3D mesh, 3D point cloud, or a 3D gaussian splat rendering approach. Such a 3D gaussian splat rendering approach may use UV mapping and generate a proxy mesh representation.

In some implementations, generating views of one or more user representations, during a communication session or otherwise, involves relighting the one or more user representations. This may involve providing an appearance of a user representation that accounts for the lighting conditions in the environment in which the user representation is to be viewed. For example, if the user representation is to be viewed within a virtual environment having virtual light sources, the appearance of the user representation may be configured to account for that lighting, e.g., color of the lighting, type of lighting, light source location, etc. In another example, if the user representation is to be viewed within an extended reality (XR) environment in which some or all of the surrounding environment is based on a physical environment, the appearance of the user representation may be configured to account for real light sources in that environment. In yet another example, an environment may include both real and virtual content, e.g., both real and virtual light sources, and a user representation may be configured to account for a combination of such real and virtual light sources.

Some implementations disclosed herein generate data (e.g., digital assets) that represent the appearance of a user to be used for a user representation. Such data may have a format that can be used to provide a view of such a user representation from different viewpoint positions, e.g., defining 3D characteristics of a user's face at one or more points in time such that a view of the face can be provided from a 3D viewpoint position relative to those 3D characteristics. Such data may have a format that can be used to provide a user representation from different viewpoints while also accounting for lighting conditions, e.g., accounting for light that is expected to be incident on the user representation in a given environment in which the user representation is to be viewed. Accounting for lighting conditions can enhance the appearance of the user representation and/or the viewing experience, e.g., providing a more realistic representation.

In some implementations, data representing a user representation includes information about 3D points that define the appearance of portions of the user representation corresponding to the 3D locations of such points. For example, data for a given 3D point may include spherical Gaussian representation data used to display 3D Gaussian Splats (3DGS) for different viewpoints. The data may include parameters for each point that identifies characteristics including, but not limited to, position, color (view/pendent/harmonics info), covariance, alpha/transparency, orientation, opacity, extent in each axis, rotation, scale, and/or semantic information (e.g., skin, hair, cheek, nose, lips, eyebrow, etc.).

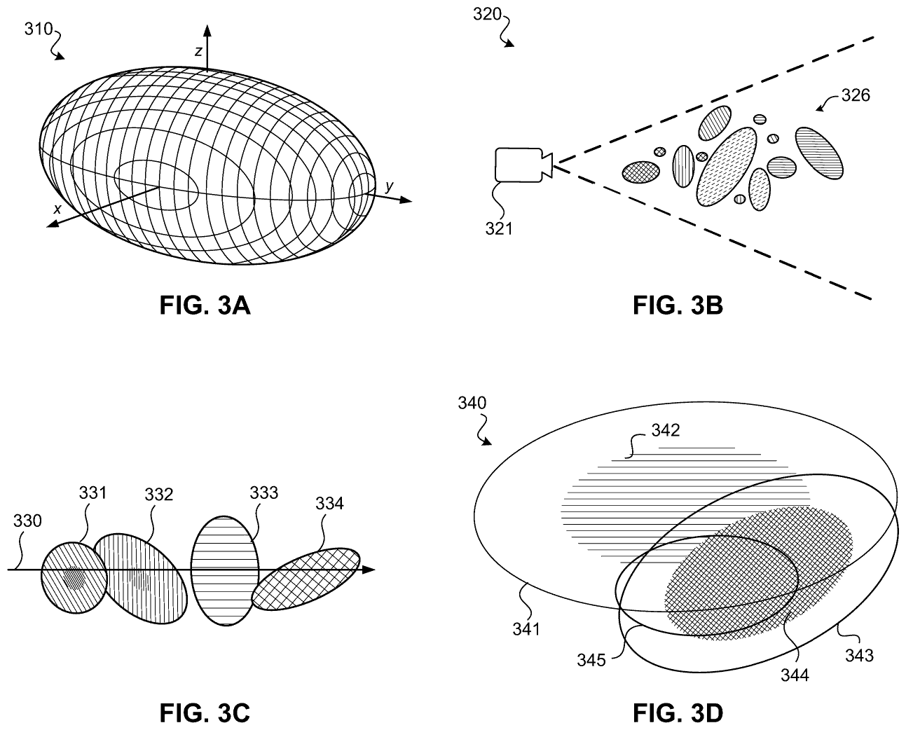

FIG. 3A-3D illustrate examples of 3D Gaussian splats for use with generating views of 3D representations in accordance with some implementations. For example, 3D Gaussian Splatting (3DGS) may be used for 3D modeling to represent complex scenes as a combination of a large number of colored 3D Gaussians which are rendered into camera views via splatting-based rasterization. The positions, sizes, rotations, colors and opacities of these Gaussian splats can then be adjusted via differentiable rendering and gradient-based optimization such that they represent the 3D scene given by a set of input images.

FIG. 3A illustrates a 3D Gaussian splat 310, e.g., an ellipsoid shape formed by a 3D gaussian distribution. The 3D Gaussian splat 310 may be used to represent a position (μ), such as xyz coordinates. The 3D Gaussian splat 310 may be used to represent direction and angle information for a cone of visibility. The 3D Gaussian splat 310 may further represent rotation and scale (e.g., [symbol] : covariance matrix), opacity (α), color (e.g., RGB values), anisotropic covariance, and spherical harmonic (SH) coefficients. FIG. 3B illustrates an environment 320 for rendering splats 326 based on a visibility direction of a camera 321. FIG. 3C illustrates ordering the splats along a camera look-at direction along a ray 330. For example, the splats 331, 332, 333, 334 are identified and ordered along the ray 330. For example, Gaussian splatting is a technique where individual 3D points are represented as Gaussian distributions (like “splats”) with color values that change depending on the viewing angle, using spherical harmonics to model this view-dependent color variation and enables real-time rendering of high-quality, photorealistic scenes from a sparse set of images. For example, each point has a color that is calculated based on its position relative to the camera, allowing for realistic shading effects across different viewpoints. FIG. 3D illustrates an environment 340 for blending splats 341, 342, 343, 344, 345 that may be viewed along the ray 330 direction from the camera view by composing the splats 331, 332, 333, 334 on an image plane. Some implementations may use screen-to-splats (e.g., similar to ray-casting techniques), splats-to-screen (e.g., similar to projection techniques), a combination thereof, or other techniques for composing splats.

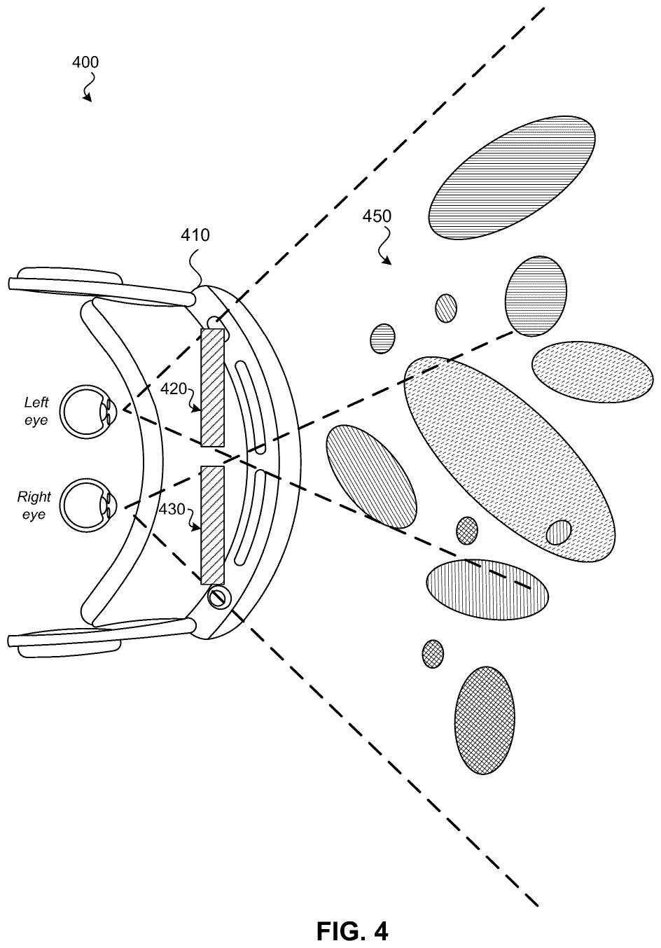

FIG. 4 illustrates an example environment 400 for generating and displaying a stereo view of splats on a device (e.g., an HMD) in accordance with some implementations. For example, the device 410 is an HMD that includes a first display 420 for a left eye view and a second display 430 for a right eye view. The first display 420 and the second display 430 may then view the rendered splats 450 for each respective viewpoint accordingly. In some implementations, the generated images for each viewpoint may be rendered as a single mono image (e.g., render for one eye), or the images may be presented as a stereo view, as illustrated in FIG. 4. Additionally, or alternatively, in some implementations, the generated images for each viewpoint may be rendered as a single grid mesh, or a combination of stereo grid meshes.

In some implementations, culling techniques for selecting a subset of the splat data for rendering a stereo view may be applied in a similar technique described herein for each eye separately, or maybe applied as culling for the overall viewer's FoV, gaze, and/or occlusions based on the viewpoint. For example, a particular splat for a left eye viewpoint may be occluded, and thus not selected to be rendered, but that same splat for a right eye viewpoint may need to be rendered to avoid any holes/gaps from the rendering for the right eye viewpoint. Alternatively, in some implementations, if only one right eye or left eye viewpoint requires that a particular splat needs to be rendered, then the system described herein will render that splat for both viewpoints to avoid any mismatches or voids for the overall stereo view of the viewer.

In some implementations, varying a rendering approach for different resolutions based on a context of a viewing experience, culling of splats, and other techniques may be used to improve rendering efficiency. As further described herein, a splat rendering approach may be selected based on one or more criterion associated with determining a context of a viewing experience and continuously updating that rendering approach (e.g., varying variance, color, size, etc. of splats using 3D Gaussian splatting rendering techniques) as the viewing experience may change.

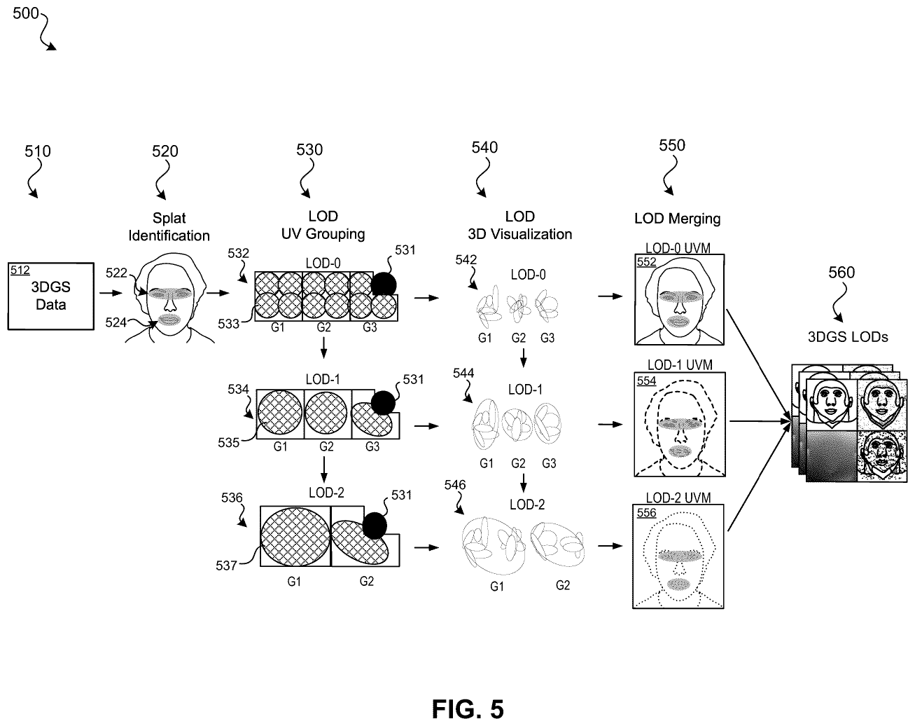

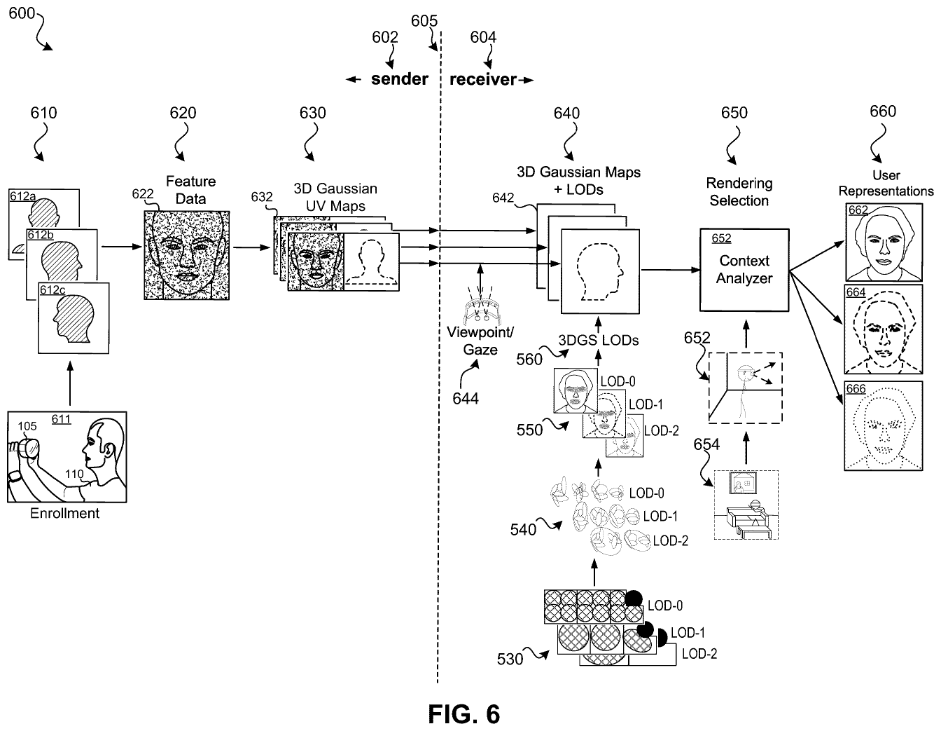

FIG. 5 illustrates an example of generating multiple sets of splats based on different level of details (LODs) by merging particular groups of splats using 3DGS parameters in accordance with some implementations. In particular, FIG. 5 illustrates an example 3DGS LODs process 500 for obtaining 3DGS data 512 from a 3DGS process 510 to generate multiple sets of 3DGS data that are based on different LODs using a merging particular groupings/hierarchy of splats based on 3DGS parameters. In some implementations, the example process of 3DGS LODs process 500 of FIG. 5 illustrates an example data flow process at enrollment stage for a sending device to generate multiple sets of splat parameter data that may be used to render a representation of the sender at a receiving device, which will be further described herein, with reference to FIG. 6.

After obtaining the 3DGS data 512, the 3DGS LODs process 500 proceeds to a splat identification process 520. The splat identification process 520 may be used to identify the splats that can be grouped as static splats during runtime (e.g., rendering an avatar) and to identify the dynamic splats that may move during runtime. For example, the splat identification process 520 may identify particular regions that may move on a persona during a communication session, such as, inter alia, region 522 (e.g., an eye region) and region 524 (e.g., a mouth region). In other words, the splats that remain as static as possible during animation (e.g., no changes in shoulder splats for a persona rendering), the system may harness the power of temporal coherence and only identify static splats to be grouped, mapped, and merged, and avoid merging particular dynamic regions, such as regions that require more detail and/or may move more during animation and rendering. For example, during a communication session, when generating personas in real-time, the mouth regions (e.g., region 524) and/or eye regions (e.g., region 522) may move during the session. Thus, those particular dynamic regions may be avoided when merging the splats.

In some implementations, the dynamic regions (e.g., moving parts of a persona such as the eyes and mouth) may be identified based on the splat data, semantics, and/or determined during an enrollment phase. For example, the system may identify splats that have had the largest splat parameter changes over a threshold period of time, which indicates that there are dynamically moving parts represented by those gaussians, the system may utilize a semantic model to identify which regions pertain to the eyes and mouth, etc., and/or the system may identify certain parts of a face that vary the most from one expression to another during an enrollment pross (e.g., while performing expressions, the mouth and eye region may move more often, and those regions could be indicative of dynamic regions). In some implementations, using temporal coherence to identify static splats to be grouped, mapped, and merged may be determined based on a predetermined model and/or may be based on learning over time (e.g., some splats just never change over a threshold period of time or a threshold period of communication sessions).

After identifying static and dynamic splats in the splat identification process 520, the 3DGS LODs process 500 proceeds to a LOD UV grouping process 530 (e.g., identify splats in the UV space). The LOD UV grouping process 530 will divide and merge static splats into groups (or grids) and for different LODs in UV space. For example, LOD-0 UV grouping 532 illustrates three exemplary groups G1, G2, G3, such that each group includes multiple static splats (e.g., splat 533). However, group G3 (e.g., an L-shaped group) excludes the dynamic splat 531 (e.g., an identified dynamic splat from region 522 or region 524). LOD-1 UV grouping 534 also illustrates three exemplary groups G1, G2, G3, but at this LOD-1 level, one or more splats are combined based on one or more 3DGS parameters. For example, the four illustrated splats of group G1 from LOD-0 UV grouping 532 may be combined as a single splat group 535 in G1 based on opacity, another 3DGS parameter, or a combination of 3DGS parameters. LOD-2 UV grouping 536 illustrates two groups G1 and G2, but at this LOD-2 level, more splats maybe combined based on one or more 3DGS parameters. For example, the splats of group G1 and G2 from LOD-1 UV grouping 534 may be combined as a single splat group 537 in G1 based on opacity, another 3DGS parameter, or a combination of 3DGS parameters. Furthermore, each level of groupings (e.g. LOD-1 UV grouping 534, LOD-2 UV grouping 536, and the like) excludes the identified dynamic splat 531.

After determining the different LOD UV groups in the LOD UV grouping process 530, the 3DGS LODs process 500 may optionally visualize the LOD UV groups in 3D space via the LOD 3D visualization process 540 (e.g., visualize the identified splats in 3D space). For example, the LOD UV grouping process 530 identifies the splat groups in UV space, and then LOD 3D visualization process 540 visualizes the splats in 3D space. The LOD 3D visualization process 540 maps the identified static splats to each of the different level groupings in 3D space. For example, LOD-0 3D data 542 identifies three groups of splats, G1, G2, and G3 at the LOD-0 level, LOD-1 3D data 544 identifies three groups of splats, G1, G2, and G3 at the LOD-1 level, and LOD-2 3D data 546 identifies two groups of splats, G1 and G2 at the LOD-2 level. The LOD UV grouping process 530 may identify which splats may be merged into one (e.g., merging via the LOD merging process 550).

The 3DGS LODs process 500 then proceeds to a LOD merging process 550 for a merging technique (e.g., UV space and 3D space merging). For example, the 3DGS LODs process 500 groups together nearby Gaussians (e.g., static splats) in 2×2, 4×4, or similar clusters into singe units based on the identification of which splats can be merged into one from the previous processes.

In some implementations, the merging process may increase the size of each splat which can distort the overall appearance of a rendering (e.g., a persona). Some merging techniques, i.e., inter alia, 3D space voxel grouping, may introduce noticeable holes after merging. However, the grouping process described herein (e.g., LOD UV grouping process 530) and the LOD merging process 550 may minimize holes or gaps between the Gaussian splats without requiring rescaling to fill these holes and maintain a cohesive representation because the 3DGS LODs process 500 follows the surface of the object. Thus, the LOD merging process 550 uses the obtained LOD mapping data, and for each level, generates UV maps for each LOD that may address the gaps in rendering.

In some implementations, the 3D points of feature data may be mapped to Gaussian parameters of a UV map (e.g., 3D points and Gaussian parameters are mapped such that the splats are arranged based on a UV mesh) to generate multiple LODs of 3D Gaussian maps (e.g., LOD-0 UVM 552, LOD-1 UVM 554, LOD-2 UVM 556, and the like) to be rendered by a specific splat generation technique (e.g., model/parameters specifying total number of splats, splat size attributes, etc. for different resolutions). For example, a UV map stores the x, y, z positions for the splat parameters (e.g., direction and angle information (cone of visibility information), color (view/pendent/harmonics information), covariance, alpha/transparency, orientation, opacity, extent in each axis, rotation, scale, semantic information (e.g., skin, hair, cheek, nose, lips, eyebrow, etc.). In an exemplary implementation, the 3DGS LODs data 560 that is generated by the LOD merging process 550 may be utilized by a viewer's device to receive 3D Gaussian UV maps associated with a sender to render a representation of the sender at the viewer's device (e.g., generating a persona of the sender during a communication session), which will be further described herein with reference to FIG. 6.

In some implementations, a rescaling technique may include selective scaling based on the splats to be rendered in an effort prevent gaps in rendering. For example, splats for a torso may be a disc or ellipsoid shape and are typically larger splats, thus gaps may be further apart and sparser. A rescaling technique may then selectively scale torso splats (e.g., scaling where splats are very larger) differently than head/face splats (e.g., torso may only need 10 k splats, but the facial area may need 50 k splats for rendering quality). The selective scaling technique may be used to determine a trade off between quality and rendering efficiency, and may be implemented into different LODs.

FIG. 6 illustrates an example of generating a representation of a user (e.g., a persona) by rendering splat parameter data using a selected splat rendering approach based on a context of a viewing experience in accordance with some implementations. In particular, FIG. 6 illustrates an example user representation process 600 for obtaining enrollment data from an enrollment process 610 (e.g., enrollment images 612a,b,c) from a sending device for a sender and a viewpoint at a receiving device for a viewer to generate a view of a user representation using a Gaussian splatting technique. Moreover, the example rendering process of user representation process 600 of FIG. 6 illustrates a data flow process between the sending device (e.g., sender phase 602) and the receiving device (e.g., receiver phase 604) as illustrated by the send/receive timeline mark 605.

Enrollment process 610 illustrates images of a user (e.g., user 110 of FIG. 1) during an enrollment process. An enrollment process 610 may include a user enrollment registration (e.g., preregistration of enrollment data) and obtaining sensor data (e.g., live data enrollment). The user enrollment registration, as illustrated in image 611, may include a user (e.g., user 110), obtaining a full view image of his or her face using external sensors on the device 105, and therefore, would take off and orient the device 105 (e.g., an HMD) towards his or her face during an enrollment process. The enrollment personification may be generated as the system obtains image data (e.g., RGB images) of the user's face while the user is providing different facial expressions. For example, the user may be told to “raise your eyebrows,” “smile,” “frown,” etc., in order to provide the system with a range of facial features for an enrollment process. An enrollment personification preview may be shown to the user while the user is providing the enrollment images to get a visualization of the status of the enrollment process. The enrollment image data 610 may include an enrollment personification with different user expressions and from different viewpoints (e.g., a front view in enrollment image 612a, a right side view in enrollment image 612b, and a left side view in enrollment image 612c). In some examples, more or less different expressions and/or viewpoints may be utilized to acquire sufficient data for the enrollment process (e.g., as illustrated in FIG. 5, a 3DGS process that starts at an enrollment stage that may generate multiple sets of 3DGS data that are based on different LODs using a merging particular groupings/hierarchy of splats based on 3DGS parameters).

In some implementations, a transformation of the enrollment image data to feature data 622 may occur by transforming (e.g., via a transformer) as part of a feature data process 620. For example, feature data 622 may include learned feature information of the user 110 obtained from the enrollment images, such as skin, color, and other semantic information per pixel. The feature data 622 may include a list of positions for each feature value (e.g., 14 feature channels). The feature data 622 may then be decoded by a decoder to generate 3D Gaussian maps for each feature as part of the Gaussian map process 630. The 3D points of the feature data may be mapped to Gaussian parameters of a UV map (e.g., 3D points+Gaussian parameters) to generate multiple 3D Gaussian maps as 3D Gaussian map data 632 to be rendered by a specific splat generation technique (e.g., model/parameters specifying total number of splats, splat size attributes, etc. for different resolutions). For example, a UV map stores the x, y, z positions for the splat parameters (e.g., direction and angle information (cone of visibility information), color (view/pendent/harmonics information), covariance, alpha/transparency, orientation, opacity, extent in each axis, rotation, scale, semantic information (e.g., skin, hair, cheek, nose, lips, eyebrow, etc.). In other words, the Gaussian map process 630 may obtain 3D point information that includes sufficient information that which splat generation can be generated (e.g., 3D vector projections).

In some implementations, a splat projection process obtains the data from the one or more representations and projects the Gaussian splats onto a 2D height field or RGBDA texture. For example, the splats may be a 3D Gaussian distribution in a 2D space with color/density (e.g., parameterization), where a person's face may be utilized as a height field, and a number of splats may be determined based on a ray off the face/height field. The height field/parameterization of the splat distribution provides higher quality data, may be faster to train a machine learning model, and may provide faster (e.g., real-time) rasterization. In some implementations, 3D mapping information (e.g., identifying x, y, z positions corresponding to UV coordinates of a UV map) may be generated at enrollment (e.g., Gaussian UV maps).

In some implementations, the process 600 proceeds after generating the 3D Gaussian map data 632 from the Gaussian UV map process 630 (e.g., at a sender's device after enrollment), the system (e.g., at viewer's device) may obtain the 3D Gaussian map data 632 (e.g., the feature data mapped to Gaussian parameters via a UV map) and project the Gaussian data using a current viewpoint (e.g., viewpoint data 644) to determine 2D Gaussian map data 642 (e.g., 2D points+Gaussian parameters) for the Gaussian map process 640 at a receiving device. In other words, a receiving device may obtain multiple sets of splats that include 3D Gaussian data that may be rendered based on a selected splat rendering approach (e.g., a rendering mode).

In some implementations, the 3D Gaussian map process 640 may include determining different LODs of 3DGS data 560 based on the 3DGS LODs process 500 of FIG. 5. For example, the Gaussian map data 642 may include multiple sets of data that are based on different LODs that are based on merging particular groupings/hierarchy of splats based on 3DGS parameters, but avoids merging regions that may move during a communication session (e.g., eye/mouth regions). In other words, the Gaussian map data 642 may be based on the LOD UV grouping data 532, 534, 538 from the LOD UV grouping process 530 that was visualized in 3D space as the LOD 3D data 542, 544, 546 from the LOD 3D visualization process 540 and merged into the LOD merging data 552, 554, 556 from the LOD merging process 550 to generate the different LODs of 3DGS data 560.

In some implementations, a splat rendering approach (e.g., a rendering mode) is selected during the rendering selection process 650. For example, a context analyzer 652 may identify a splat rendering model (e.g., high resolution versus a lower resolution splat model) based on sensor data 652 of a viewing environment, which may include the viewpoint/gaze data 644 of the viewer, and the sender data 654. For example, user/scene understanding information may be obtained to determine different contexts, such as, inter alia, identifying a viewpoint distance, determining whether the user capturing a picture/video, speaking to a specific persona, saying the name of a user represented by a persona in the user's field of view, and the like. In some implementations, a viewing experience may be an experience in which a view of a representation of the at least the portion of the object will be rendered based on a viewpoint in a 3D environment. For example, a scene understanding of a physical environment may be obtained or determined by the device 105 based on depth data and light intensity image data. For example, a user 110 may scan the environment that he or she is located in, and based on the image data (e.g., light intensity and/or depth), a scene understanding instruction set (e.g., context analyzer 652 of FIG. 6) may determine information for the physical environment (e.g., objects, people within the environment, etc.) to track object-based data based on generating a scene understanding of the environment. Additionally, a user/scene understanding may be used to determine a context of the experience and/or the environment (e.g., create a scene understanding to determine the objects or people in the content or in the environment, where the user is, what the user is watching, etc.). The sender data 654 may include additional context data that may be used by the context analyzer 652 to determine a splat rendering approach (e.g., a sender or a sender's device may send information that requires a higher resolution splat rendering, i.e., to take a picture or have a higher resolution for a certain persona (among other personas in the environment) that the user is interacting/speaking with during a communication session).

In some implementations, the context analyzer 652 determines a context of the viewing experience based on one or more different criterion and may continuously update the determined context such that the splat rendering approach and may be updated frame to frame. In some implementations, a context of a viewing experience may be based on a distance to a user (e.g., a user can see more detail of personas up close than far away, and those personas are more likely to be interacting with the user). In some implementations, a context of a viewing experience may be based on a detected user speech (e.g., user speaks name of a certain persona which will cause that persona to be rendered at a high resolution). In some implementations, a context of a viewing experience may be based on detected speech of persona speaking to the user (e.g., a persona could say user's name and start talking about something and the rendering approach would change to a higher resolution). In some implementations, a context of a viewing experience may be based on detected user intent to communicate with a certain persona and/or sensor fusion (e.g., gaze and spoken word and hand gestures). For instance, if a persona is not interacting with the user, then the persona may be switched to be rendered at a lower resolution, but then when a persona speaks a user's name indicating that he/she wants to interact with the user, the persona may still be rendered at a lower resolution until the user gazes over at the persona that spoke the user's name. Thus, in an exemplary implementation, the resolution modifications that are continuously updated during a viewing experience based on the context may be modified based on one more 3D gaussian specific parameters (e.g., variance, size, color, etc.).

After the rendering selection process 650 and a splat rendering approach is selected (e.g., high resolution (e.g., 64 k or LOD-0) versus a lower resolution (e.g., 32 k, 16 k, LOD-1, LOD-2, etc.) splat rendering model), then Gaussian splatting may be used for the rendering to generate a view of a user representation for the user representation generation process 660. For example, a user representation for the user representation generation process 660 may generate a high-resolution user representation 662, a medium resolution user representation 664, or a low-resolution user representation 666, depending on the selected splat rendering approach and the determined context of the viewing experience. For example, a 3D Gaussian splatting technique uses the 2D points from a map (e.g., a UV map) and the associated Gaussian parameters to render an image using Gaussian splatting based on the current viewpoint of the viewer (e.g., viewpoint and gaze data 644) based on the selected splat rendering approach. The rendering of each representation 662, 664, 666 is illustrated as a user representation (e.g., a persona), but the Gaussian splatting techniques described herein may be used for any 3D object or 3D scene reconstruction.

In some implementations, the splat rendering approach for generating the different user representations 662, 664, 666, may vary and may be adjusted based on resolution, different size of splats, different colors or less color spectrums, different number of gaussians rendered along a viewing ray 330, or a combination thereof. For example, as illustrated in FIG. 3C, a high-resolution splat rendering technique can render more gaussian splats along the viewing ray 330 while a lower resolution can render maybe only the first and/or second splat. In some implementations, a lower resolution splat rendering technique may use proxy rendering. For example, a proxy representation process may be used to generate a 3D proxy representation (e.g., a textured 3D mesh, a textured heightfield, etc.) that is easier to render and uses this 3D proxy representation to render the additional views needed to provide the views at the faster rate (e.g., for the second and third frames needed to provide views of 30 Hz content at 90 Hz).

The various implementations discussed herein for each splat rendering technique to generate different versions of quality of representations (e.g., low to high resolution) are merely exemplary and is not meant to be limiting. For example, other embodiments may have more or less than three different levels of resolution (e.g., low, medium, high, LOD-1, LOD-2, LOD-3, etc.), and some embodiments may not have discrete levels and may have a continuous, sliding bar approach that may be adjusted based on the context of the viewing experience as it may change frame-to-frame.

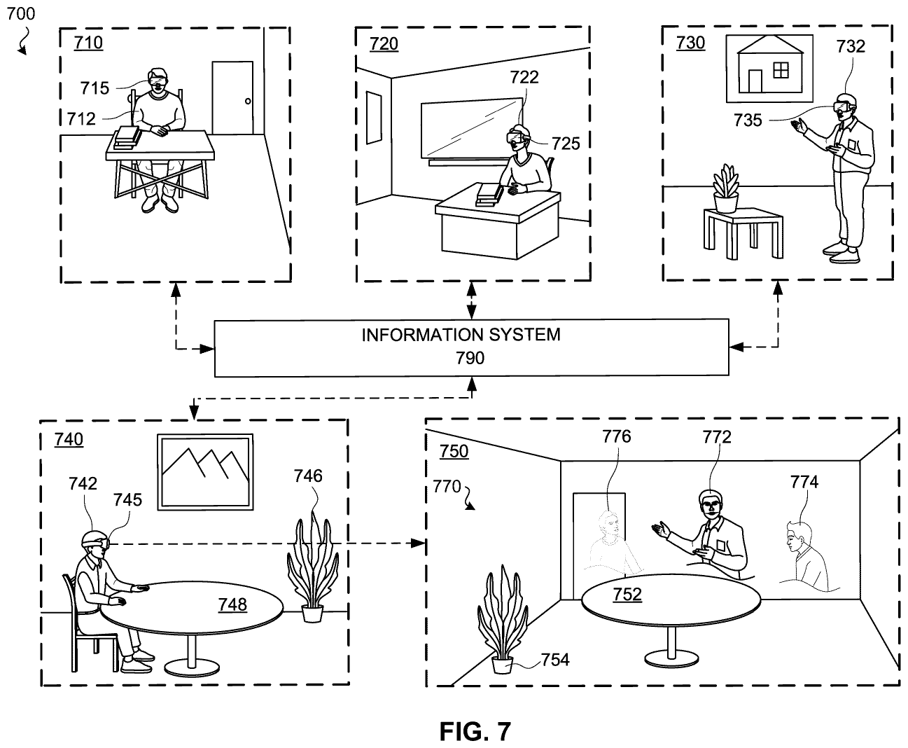

FIG. 7 illustrates exemplary electronic devices operating in different physical environments during a communication session with multiple users, that includes a view of 3D representations of the other users using a selected splat rendering approach in accordance with some implementations. For example, FIG. 7 illustrates exemplary operating environment 700 of electronic devices 715, 725, 735, and 745 operating in different physical environments 710, 720, 730, 740, respectively, during a communication session, e.g., while the electronic devices 715, 725, 735, and 745 are sharing information with one another or an intermediary device such as a communication session system/server (e.g., information system 790). Similar to the communication session illustrated in FIG. 2, FIG. 7 illustrates a communication session between users 712, 722, 732, and 742 while wearing devices 715, 725, 735, and 745 (e.g. HMDs), respectively.

In this example of FIG. 7, each physical environment 710, 720, 730, 740 is a room that includes a user and one or more objects as each user is viewing an environment on each respective device. The electronic devices 715, 725, 735, and 745 may include one or more cameras, microphones, depth sensors, or other sensors that can be used to capture information about and evaluate each physical environment and the objects within it, as well as information about each user of each electronic device. The information about the physical environment and/or user may be used to provide visual content (e.g., for user representations) and audio content (e.g., for audible voice or text transcription) during the communication session. For example, a communication session may provide views to one or more participants of a 3D environment that is generated based on camera images and/or depth camera images of a physical environment, and provide views of one or more user representations of each user of the communication session.

FIG. 7 further illustrates an example of a view 750 of a virtual environment (e.g., 3D environment 770) at device 745 for user 742. In particular, the view 750 for user 742 provides a representation 752 of the table 748 and a representation 754 of the plant 746 from environment 740. Furthermore, the view 750 for user 742 provides user representations 772, 774, 776 of user's 712, 722, 732, respectively (e.g., a persona of each user of the communication session) positioned around the representation 752 of the table 748. In other words, FIG. 7 illustrates multiple people in different physical locations, each wearing an HMD and have enrolled their personas and thus have 3D gaussian representations. All of these users are then in a shared visual space, such as a virtual conference room and the user representations are positioned around a virtual table (e.g., representation 752), and there are many gaussian representations of those users who are wearing headsets in their own respective physical environments, but just appear to be in the same virtual or mixed reality environment. In particular, each user representation 772, 774, 776 is generated in real time using a selected splat rendering approach at the receiving device (e.g., device 745). For example, a splat rendering approach may select a higher resolution representation versus a lower resolution splat rendering model based on one more criterion (e.g., a context of a viewing experience), as discussed herein. Gaussian splatting may be used for the rendering to generate a view each user representation 772, 774, 776. For example, a user representation may be generated using a splat rendering technique (e.g., user representation generation process 660 of FIG. 6) to provide a view of a high resolution user representation 772, a medium resolution user representation 774, or a low resolution user representation 776, depending on the selected splat rendering approach and the determined context of the viewing experience.

In some implementations, the context analyzer 652 of FIG. 6 determines a context of the viewing experience based on one or more different criterion and may continuously update the determined context such that the splat rendering approach and may be updated frame to frame. In some implementations, a context of a viewing experience may be based on a distance to a user (e.g., a user can see more detail of personas up close than far away, and those personas are more likely to be interacting with the user). For example, the representation 772 is shown in a higher detail/resolution because it is closer to the view of the user 742. In some implementations, a context of a viewing experience may be based on a detected user speech (e.g., user speaks name of a certain persona which will cause that persona to be rendered at a high resolution). For example, the representation 772 may be shown in a higher detail/resolution because that user is speaking to the user 742 (e.g., as illustrated, user 732 is standing, talking, and moving his or her hands, thus the representation 772 is updated accordingly). In some implementations, a context of a viewing experience may be based on detected speech of persona speaking to the user (e.g., a persona could say user's name and start talking about something and the rendering approach would change to a higher resolution). In some implementations, a context of a viewing experience may be based on detected user intent to communicate with a certain persona and/or sensor fusion (e.g., gaze and spoken word and hand gestures). For instance, if a persona is not interacting with the user, then the persona may be switched to be rendered at a lower resolution, but then when a persona speaks a user's name indicating that he/she wants to interact with the user, the persona may still be rendered at a lower resolution until the user gazes over at the persona that spoke the user's name. For example, the representation 774 may have called the user's name 742, and then once the viewer (e.g., user 742) gazes towards that representation 774, then the system may improve the resolution of the representation 774 (e.g., a higher resolution, such as like representation 774). Thus, in an exemplary implementation, the resolution modifications that are continuously updated during a viewing experience based on the context may be modified based on one more 3D gaussian specific parameters (e.g., variance, size, color, etc.).

Additionally, in the example of FIG. 7, the 3D environment 770 is an XR environment that is based on a common coordinate system that can be shared with other users (e.g., a virtual room for personas for a multi-person communication session). In other words, the common coordinate system of the 3D environment 770 is different than the coordinate system of the physical environments. For example, a common reference point may be used to align the coordinate systems. In some implementations, the common reference point may be a virtual object within the 3D environment that each user can visualize within their respective views. For example, a common center piece table that the user representations (e.g., the user's personas) are positioned around within the 3D environment. Alternatively, the common reference point is not visible within each view. For example, a common coordinate system of a 3D environment may use a common reference point for positioning each respective user representation (e.g., around a table/desk, such as representation 752). Thus, if the common reference point is visible, then each view of the device would be able to visualize the “center” of the 3D environment for perspective when viewing other user representations. The visualization of the common reference point may become more relevant with a multi-user communication session such that each user's view can add perspective to the location of each other user during the communication session.

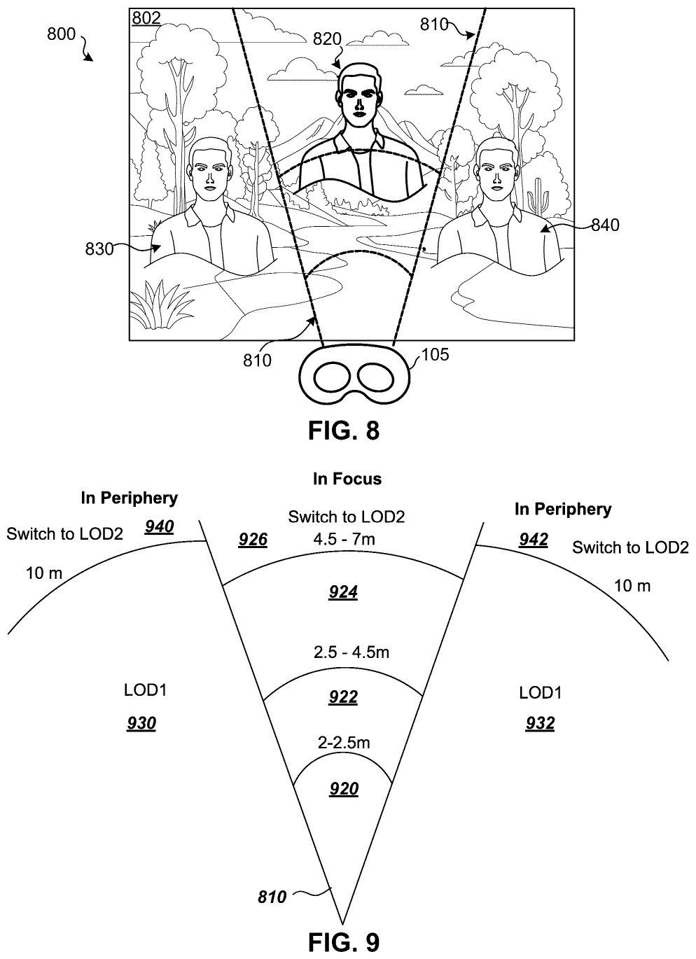

FIG. 8 illustrates an example view 800 of a 3D environment 802 provided by the device of FIG. 1 (e.g., device 105), in accordance with some implementations. In particular, FIG. 8 illustrates a stereo view 800 of a 3D environment 802 that includes three different personas 820, 830, 840 that are in different 3D locations with respect to a viewpoint of a user of the device 105 as provided by gaze cone 810. The gaze cone 810 demonstrates an example foveal region within the user's FoV with respect to a gaze vector (e.g., the user's gaze) of the 3D environment 802. In other words, the foveal region is the gaze cone 810 around the gaze vector. Moreover, the gaze cone 810 illustrates the 3D positions at which an object may be depicted within the 3D environment 802 with respect to the user's gaze vector (e.g., a 3D location of each persona 820, 830, 840 from the user's viewpoint). Specifically, the gaze cone 810 illustrates the user's foveal region of the user's FoV based on a gaze vector, such that the regions outside of the gaze cone 810 (foveal region), but within the user's view, are the peripheral regions.

In this example illustrated in FIG. 8, the persona 820 is located within the foveal region of the gaze cone 810 and thus may be rendered at with a higher level-of-detail (e.g., 64 k splats). By contrast, the persona 830 and persona 840 are each located outside of the gaze cone 810 but within the user's field of view (e.g., in the periphery), thus persona 830 and persona 840 may be rendered with a lower level-of-detail (e.g., 16 k splats), leveraging the human visual system's reduced sensitivity to peripheral changes. In other words, the system dynamically adjusts the level-of-detail of each persona based on its relevance to the user's current focus, such as gaze direction or field of view (FoV). This approach enables efficient use of GPU resources, higher overall frame rates, and improved battery life, without perceptible loss of visual quality in the periphery.

FIG. 9 illustrates different regions associated with the example gaze cone 810 of FIG. 8 based on viewpoint characteristics, in accordance with some implementations. In particular, FIG. 9 illustrates how the gaze cone 810 (e.g., a foveal region of the user's field of view) may be utilized to provide a dynamic, context-aware system for rendering 3D representations using 3D Gaussian splats, with advanced LOD transitioning based on distance, gaze, and field of view. The approach minimizes visual artifacts during LOD changes, optimizes rendering efficiency, and maintains high visual fidelity in regions of interest.

For example, the foveal region (e.g., gaze cone 810) includes regions 920, 922, 924, 926 that may each be triggered to transition between different LODs based on a distance associated with a 3D position at which at least a portion of an object representation (e.g., persona 820) is to be depicted within a 3D environment. For example, as the persona 820 becomes further away from the viewpoint of the user, the system may transition between LOD levels gradually using merging techniques before switching to that lower level of detailed representation. In other words, the regions may define transition zones (e.g., switching from region 920 to region 922—starting at 2-2.5 meters) where splats are merged in groups, reducing the total number of splats (e.g., from 64 k to 16 k) before swapping to a lower-LOD persona. For instance, personas in region 920 may be rendered at LOD-0, in region 922 may be rendered at LOD-0 and/or LOD-1, in region 924 may be rendered at LOD-1 and/or LOD-2 and in region 926 may be rendered at LOD-2. This process for transition merging may be continuous and may be adjusted based on distance thresholds.

Moreover, for the transition merging, intermediate LOD states may be utilized (e.g., a combination of LOD-0 and LOD-1). For example, the exact proportion of each LOD state varies with distance, more LOD-0 closer to the camera, and more LOD-1 further away from the camera. The runtime algorithm producing the LOD states operates by merging splats into bigger splats. In some implementations, this algorithm does not necessarily need to output a fixed number of merged splats, but can choose a variable number of splats to merge (either stochastically or in a predetermined manner), and this variable number can be controlled by knobs, such as distance or angle to the camera.

In some implementations, this same process may be based on angular thresholds as the user may change his or her field of view and/or gaze direction. For example, as a persona transitions to the periphery (e.g., transitioning from one of the foveal regions 920, 922, 924, 926 to one of the peripheral regions 930, 932, 940, 942). In some implementations, splat size reduction may be based on the angular degree of the gaze. Moreover, this process may be combined for both angular threshold (gaze direction) and persona distance threshold. For example, transitioning from region 924 to 940, both an angular threshold and distance threshold may be gradually applied before transitioning to LOD-2. In other words, the merging of splats may not be uniform across a persona. Instead, the system uses gaze tracking to determine which regions are in the viewer's focus and maintains higher detail in those regions, while more aggressively merging splats in peripheral or less-attended areas. The angle to the gaze center and field of view are used to direct the merging process.

In some implementations, the peripheral regions 930, 932, 940, 942 (e.g., outside the foveal region) may be prohibited from rendering at a highest level of resolution (e.g., LOD-0). In other words, the foveal region may allow rendering based on a first set of LODs (e.g., LOD-0, LOD-1, and LOD-2) and the peripheral region may allow rendering based on a second set of LODs different from the first set (e.g., LOD-1 and LOD-2 only).

In some implementations, in peripheral regions (outside the foveal region), the system can switch to sparser UV representations, allowing for more aggressive LOD reduction without perceptible loss of detail. Furthermore, the number of splats can be dynamically increased or decreased (e.g., between 8 k and 64 k) as the viewer's distance or gaze changes, providing a seamless user experience. In some implementations, to prevent flicker during transitioning/merging, rescaling of splats may be utilized to prevent gaps in the splats. Additionally, or alternatively, in some implementations, to prevent flicker during transitioning/merging, the gaze cone 810 and/or the regions within the gaze cone 810 (foveal region) or outside of the gaze cone 810 (e.g., in the periphery) may be increased or decreased in size and/or threshold levels depending on the LOD, a context of the viewing experience, and/or the viewpoint characteristics associated with a current view.

In some implementations, the transition merging of splats, as the rendered views are continuously updated between LODs, includes deterministically computing a merge ratio. For example, the system may start merging groups of splats as they cross a distance boundary (e.g., from region 922 to 924) by deterministically computing the merge ratio. In some implementations, all groups of splats may not be immediately merged. In some implementations, a threshold for merging may become lower and lower the further past the distance boundary and/or angular boundary that the persona is. This merging of splats allows the system to create a large number of intermediate LOD states, that helps the system smoothly transition to the fixed LOD states (e.g., from merging all splat groups, such as LOD-0, LOD-1, LOD-2, and the like).

Additionally, or alternatively, in some implementations, stochastic merging of splats may be utilized. For example, a mask (created via a random distribution) may be used for the transition merging, where, if that mask has a value above some threshold, the system may determine to merge the splats of that group. Using a low discrepancy random distribution may also further help feather and hide any noticeable “popping” effects to a viewer during a transition. This partial merging of splats allows the system to create a large number of intermediate LOD states, that helps the system smoothly transition to the fixed LOD states (e.g., from merging all splat groups, such as LOD-0, LOD-1, LOD-2, and the like).

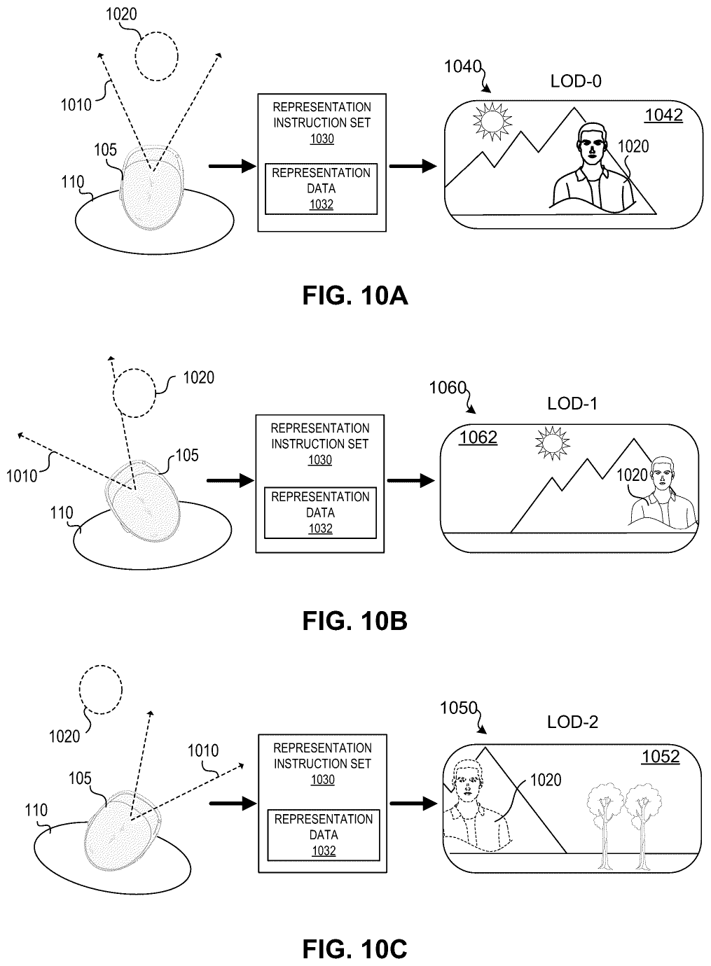

FIG. 10A-10C illustrate different examples of rendering a user persona at different level of details based on viewpoint characteristics (e.g., a user's current focus, such as gaze direction or field of view), in accordance with some implementations. In particular, FIG. 10A-10C illustrate a process for a representation instruction set 1030 that dynamically provides context-based selection and transitioning between LODs for rendering a persona 1020, with a focus on minimizing perceptible transition artifacts and optimizing for both distance, gaze, and field of view changes associated with the user's 110 viewpoint with respect to the 3D position of the rendered persona 1020. In other words, based on whether the persona 1020 is inside or outside of the user's central field of view (e.g., foveal region or periphery), which may be determined based on the user's perspective, gaze, and/or the position of the persona 1020 relative to a field of view centerline. For example, FIG. 10A illustrates a process for generating the persona at a higher level-of-detail (e.g., LOD-0 (˜64 k splats)), FIG. 10B illustrates a process for generating the persona at an intermediate level-of-detail (e.g., LOD-1 (˜32 k splats)), and FIG. 10C illustrates a process for generating the persona at a lower level-of-detail (e.g., LOD-2 (16 k splats or less)).

As illustrated in FIG. 10A, a user 110 wearing device 105 has a field of view that includes a view of the persona 1020 in a foveal region (e.g., gaze cone 1010). A representation instruction set 1030 may then generate representation data 1032 to render a view 1040 of a 3D environment 1042, utilizing one or more techniques for generating views described herein. As illustrated in FIG. 10A, the persona 1020 in the view 1040 is centered within the user's 110 foveal (in-focus) region with respect to the background (e.g., mountains) in order to generate a higher fidelity view of the persona (e.g., higher quality—more splats—with perceived stereo depth).

As illustrated in FIG. 10B, a user 110 wearing device 105 has a foveal region (e.g., gaze cone 1010) within a field of view that includes a view of the persona 1020 in a peripheral region—where the position of the persona 1020 is right relative to a FOV centerline. In other words, either the gaze and/or head position of the user 110 has moved relative to the 3D position of the persona 1020 and/or the 3D position of the persona 1020 has moved in the view of the 3D environment relative to the gaze and/or head position of the user 110 such that the 3D position of the persona 1020 is now mainly outside (to the right of) the user's 110 field of view, however, a portion of 3D position of the persona is slightly within the user's 110 foveal region, as depicted by gaze cone 1010. In other words, as the user 105 moved his or her head (or gaze direction) to the left, a transition may occur from LOD-0 in FIG. 10A to LOD-1 in FIG. 10B. Thus, a representation instruction set 1030 may then generate representation data 1032 to render a view 1060 of a 3D environment 1062, utilizing one or more techniques for generating transitional views (merging) as described herein. As illustrated in FIG. 10B, the persona 1020 in the view 1060 is mostly in the periphery of the user's 110 foveal region (gaze cone 1010), but a portion is still slightly within the gaze cone 1010 with respect to the background (e.g., now looking to the left of the mountains). Thus, the system may determine to transition to and generate an intermediate-fidelity view of the persona (e.g., transitioning/merging from LOD-0 64 k splats to LOD-1 32 k splats).

As illustrated in FIG. 10C, a user 110 wearing device 105 has a field of view that includes a view of the persona 1020 in a peripheral region—where the position of the persona 1020 is left relative to a field of view centerline of a foveal region (gaze cone 1010). In other words, either the gaze and/or head position of the user 110 has moved relative to the 3D position of the persona 1020 and/or the 3D position of the persona 1020 has moved in the view of the 3D environment relative to the gaze and/or head position of the user 110 such that the 3D position of the persona 1020 is now outside (to the left of) the user's 110 field of view and further away as depicted by gaze cone 1010. A representation instruction set 1030 may then generate representation data 1032 to transition to LOD-2 and render a view 1050 of a 3D environment 1052, utilizing one or more techniques for generating transition/merging views described herein. As illustrated in FIG. 10C, the persona 1020 in the view 1050 is in the periphery of the user's 110 foveal region with respect to the background (e.g., now looking to the right of the mountains) in order to generate a lower fidelity view of the persona (e.g., rendered with a quality—less splats, as the human visual system is less sensitive to changes and/or image quality in the periphery).

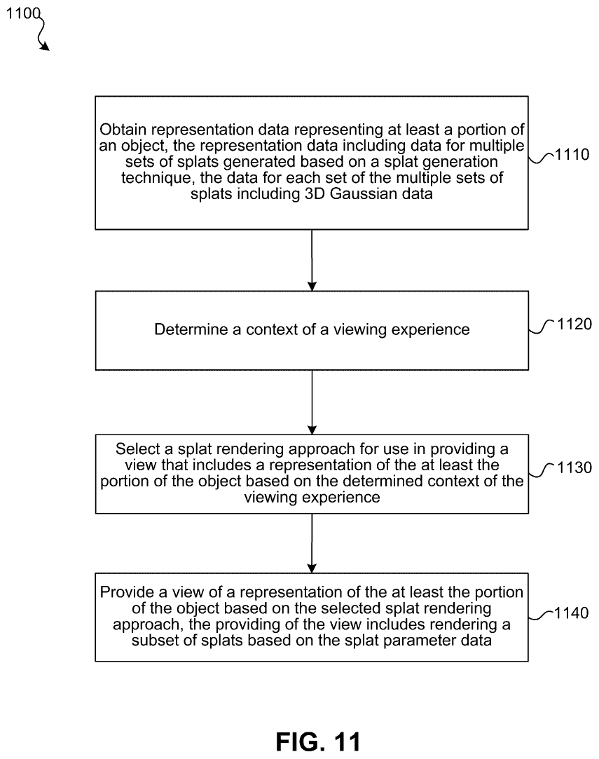

FIG. 11 is a flowchart illustrating an exemplary method 1100. In some implementations, a device (e.g., device 105 of FIG. 1) performs the techniques of method 1100 to provide a view of a representation by rendering splat parameter data using a selected splat rendering approach based on a context of a viewing experience in accordance with some implementations. In some implementations, the techniques of method 1100 are performed on a mobile device, desktop, laptop, HMD, or server device. In some implementations, the method 1100 is performed on processing logic, including hardware, firmware, software, or a combination thereof. In some implementations, the method 1100 is performed on a processor executing code stored in a non-transitory computer-readable medium (e.g., a memory). In some implementations, the method 1100 is implemented at a processor of a device, such as a viewing device, that renders the user representation (e.g., device 210 of FIG. 2 renders 3D representation 240 of user 260 (a persona) from data obtained from device 265).

At block 1110, the method 1100, at a processor of a device, obtains representation data representing at least a portion of an object, the representation data including data for multiple sets of splats generated based on a splat generation technique, the data for each set of the multiple sets of splats including 3D Gaussian data. For example, a splat generation technique (e.g., model/parameters specifying total number of splats, splat size attributes, etc.) may include generating multiple sets of splat parameter data (e.g., sets of splat parameter data ranging in different resolutions/sizes from 16 k splats to 64 k splats, or different LODs based on merged groupings of static splats, and the like). In some implementations, the representation data may be rendered using Gaussian splatting, which is a technique where individual 3D points are represented as Gaussian distributions (e.g., splat parameter data, also referred to as “splats”) with color values that change depending on the viewing angle, using spherical harmonics to model this view-dependent color variation and enables real-time rendering of high-quality, photorealistic scenes from a sparse set of images. For example, each point has a color that is calculated based on its position relative to the camera, allowing for realistic shading effects across different viewpoints.

In an exemplary implementation, the device is a viewing device that renders a representation of the object, such as a user representation (e.g., a persona). In some implementations, the at least the portion of the object (e.g., a person) includes a face portion and an additional portion of the user (e.g., head, neck, clothes, hair, body, etc. of a user of sending device). In other words, the method 1100 is at a viewer's device that provides a view of a representation of a sender based on data from a sender's device. In an exemplary implementation, a user representation (e.g., a persona) of the sender is provided for viewing, however, the techniques described herein (e.g., Gaussian splatting culling) may render any type of object or scene for reconstruction of viewing at the viewer's device.

In some implementations, the user representation data is based on UV maps and 3D point cloud points associated with distribution data defining sizes and shapes for rendering the 3D point cloud points as splats corresponding to each point of the UV maps (e.g., 3D Gaussian map). For example, as illustrated in FIG. 6, the user representation 662 may be generated for a particular viewpoint based on rendering the points from a Gaussian UV map 642 after a rendering selection process 650.

In some implementations, the splat parameter data includes 3D Gaussian parameters. For example, the splat parameter data may include position information (e.g., a 3D position), direction and angle information (e.g., a cone of visibility), color information, covariance information, transparency information, an orientation, opacity information, extent information in each axis, rotation data, a scale, and/or semantic information (e.g., skin, hair, cheek, nose, lips, eyebrow, etc.). For example, as illustrated in FIG. 6, the 3D Gaussian map process 630 generates 3D Gaussian Map data 632 (e.g., multiple sets of splat parameter data) by transforming the enrollment image data to multiple sets of feature data which may include learned feature information of a user obtained from the enrollment images, such as skin, color, and other semantic information per pixel. For example, a splat parameter position may identify where a splat is located based on xyz coordinates, a splat parameter covariance may identify how a splat is stretched/scaled (e.g., a 3×3 matrix), a splat parameter color may identify an RGB color, and a splat parameter alpha (α) may identify how transparent is the splat. In some implementations, the user representation data includes 3D point cloud points associated with distribution data defining sizes and shapes for rendering 3D point cloud points as splats. For example, a splat model generated using Gaussian splats that includes texture/color, position, splat shape, and the like. In some implementations, the user representation data includes 3D mapping information that includes feature values and position information for each map point (e.g., identifying x, y, z positions corresponding to UV coordinates of a UV map).

In some implementations, the splat generation technique includes a splat criterion associated with a resolution of each splat associated with each of the multiple sets of splats (e.g., a quality splat threshold). In some implementations, the splat generation technique includes a splat criterion associated with a quantity of splats associated with each of the multiple sets of splats (e.g., a number splat threshold such as 32 k vs 64 k). In some implementations, the splat generation technique includes a splat criterion associated with a size of each splat associated with each of the multiple sets of splats (e.g., a size splat threshold).

In an exemplary implementation, the multiple sets of splats may be determined based on different level of details (LODs) that are determined based on merging particular static groupings/hierarchy of splats based on 3DGS parameters, but avoiding merging dynamic regions that may likely move during a communication session (e.g., eye/mouth regions). Thus, for the method 1100, in some implementations, each of the multiple sets of splats are based on a different LOD. In some implementations, the splat generation technique includes a splat criterion associated with merging a plurality of subsets of splats based on the splat parameter data. In some implementations, the plurality of subsets of splats are selected based on determining one or more static regions associated with representing the at least the portion of the object. For example, multiple sets may be based on different LODs that are based on merging particular static groupings/hierarchy of splats based on 3DGS parameters, but avoiding merging regions that move during a communication session (e.g., eye region 522 and mouth region 524 that were identified by the static/dynamic splat identification process 520). In some implementations, the merging of the plurality of subsets of splats is determined (e.g., generated and/or updated) at a rendering device (e.g., a viewer's device that render's a persona of a sender after receiving the 3D Gaussian data). Additionally, or alternatively, in some implementations, the merging of the plurality of subsets of splats is determined (e.g., generated and/or updated) during an enrollment process (e.g., a sender's device generates the 3D Gaussian LODs and then sends the LODs of 3D Gaussian data to a viewer's device that render's a persona of the sender based on receiving the 3D Gaussian data and the different LODs based on live data).

At block 1120, the method 1100 determines a context of a viewing experience. For example, user/scene understanding information may be obtained to determine different contexts, such as, inter alia, identifying a viewpoint distance, determining whether the user capturing a picture/video, and the like. In some implementations, a viewing experience may be an experience in which a view of a representation of the at least the portion of the object will be rendered based on a viewpoint in a 3D environment. For example, a scene understanding of a physical environment may be obtained or determined by the device 105 based on depth data and light intensity image data. For example, a user 110 may scan the environment that he or she is located in, and based on the image data (e.g., light intensity and/or depth), a scene understanding instruction set (e.g., context analyzer 652 of FIG. 6) may determine information for the physical environment (e.g., objects, people within the environment, etc.) to track object-based data based on generating a scene understanding of the environment. For example, a scene understanding may be used to more accurately track the movements of the user 110 relative to the environment. Additionally, a scene understanding may be used to determine a context of the experience and/or the environment (e.g., create a scene understanding to determine the objects or people in the content or in the environment, where the user is, what the user is watching, etc.).

In some implementations, the context of the viewing experience includes a viewpoint of the view of the representation and selecting the splat rendering approach for use in providing a view is based on a threshold distance associated with the viewpoint. For example, use a lower quality set of splats generated using a 32K splat model or splats based on the LOD-1, LOD-2, or similar divided/merged groupings, when the viewpoint is more than a threshold distance away, and use a higher quality set of splats generated using the 64K splat model (e.g., splats that have not been divided/merged into groups, e.g., LOD-0) when the viewpoint is less than the threshold. Additionally, or alternatively, in some implementations, the context of the viewing experience includes recording of at least one frame of content associated with a viewpoint of the view of the representation and selecting the splat rendering approach for use in providing a view is based on the recording of the at least one frame of content. For example, use the 64K splat model with the viewer is capturing a picture/video.

At block 1130, the method 1100 selects a splat rendering approach (e.g., a rendering mode) for use in providing a view that includes a representation of the at least the portion of the object based on the determined context of the viewing experience. For example, using a lower resolution splat model when the viewpoint is more than a threshold distance away (e.g., a 32K splat model, or a LOD that has been divided/merged, e.g., LOD-1, LOD-2, etc.), or use the set of splats generated using a higher resolution splat model (e.g., a 64K splat model, or a LOD that has not been divided/merged, e.g., LOD-0), when the viewpoint is less than the threshold. For example, a threshold distance may be based on a perceived distance (e.g., an apparent distance of a view to the representation during a rendering of a view). For example, if the perceived distance of the representation to be rendered is further than a perceived distance threshold (e.g., in the background of a current view), then a lesser quality of a rendering of the representation may be selected. On the other hand, if the perceived distance of the representation to be rendered is closer than a perceived distance threshold (e.g., a user representation (persona) during a communication session), then a higher quality of a rendering of the representation may be selected. Additionally, a determined context of a viewing experience may indicate that the viewer is taking a picture or recording a video of the viewing experience, thus it would be desirable to render a higher quality representation.

In some implementations, a context analyzer determines a context of the viewing experience based on one or more different criterion and may continuously update the determined context such that the splat rendering approach and may be updated frame to frame. In some implementations, a context of a viewing experience may be based on a distance to a user (e.g., a user can see more detail of personas up close than far away, and those personas are more likely to be interacting with the user). For example, the representation 772 is shown in a higher detail/resolution because it is closer to the view of the user 742. In some implementations, a context of a viewing experience may be based on a detected user speech (e.g., user speaks name of a certain persona which will cause that persona to be rendered at a high resolution). For example, the representation 772 may be shown in a higher detail/resolution because that user 732 is speaking towards the user 742 (e.g., representation 772 is shown facing the viewer, user 742, as the user 732 is speaking and moving his or her hands, such as during a group presentation).

In some implementations, a context of a viewing experience may be based on detected speech of persona speaking to the user (e.g., a persona could say user's name and start talking about something and the rendering approach would change to a higher resolution). In some implementations, a context of a viewing experience may be based on detected user intent to communicate with a certain persona and/or sensor fusion (e.g., gaze and spoken word and hand gestures). For instance, if a persona is not interacting with the user, then the persona may be switched to be rendered at a lower resolution, but then when a persona speaks a user's name indicating that he/she wants to interact with the user, the persona may still be rendered at a lower resolution until the user gazes over at the persona that spoke the user's name. For example, the representation 774 may have called the user's name 742, and then once the viewer (e.g., user 742) gazes towards that representation 774, then the system may improve the resolution of the representation 774 (e.g., a higher resolution, such as like representation 774). Thus, in an exemplary implementation, the resolution modifications that are continuously updated during a viewing experience based on the context may be modified based on one more 3D gaussian specific parameters (e.g., variance, size, color, etc.).

At block 1140, the method 1100 provides a view of a representation of the at least the portion of the object based on the selected splat rendering approach, the providing of the view includes rendering a subset of splats based on the splat parameter data. For example, a selected splat rendering approach (e.g., selecting a rendering mode, such as, a high resolution versus a lower resolution rendering) may be used to render a view of a user presentation (e.g., a persona), or a rendering of another object or scene. Furthermore, 3D Gaussian splatting may be used to avoid or fill holes, body pose data may be applied to include additional areas of the user (e.g., neck/shoulder area). For example, as illustrated in FIG. 6, a user representation 662, 664, 666, etc., is generated for a particular viewpoint based on rendering the points from the Gaussian map 642 which combines the obtained splat parameters from enrollment data, and updated for each frame based on one or more marker points (e.g., a set of semantic points associated with facial features or other areas corresponding to the sender associated with a rendered user representation 662, 664, 666, etc.).

In some implementations, selecting the splat rendering approach includes selecting between a first approach that renders a first set of the multiple sets of splats and a second approach that renders a second set of the multiple sets of splats, wherein the first set of multiple sets of splats has more splats than the second set of the multiple sets of splats. For example, the system may determine whether to select LOD-0 (64 k splats) or LOD-1 (32 k splats).

In some implementations, selecting the splat rendering approach includes selecting an approach that reduced a level of rendering detail by switching to rendering a lower level-of-detail representation, rendering the lower representation including merging a (second) subset of splats in a transition zone based on a position at which the at least the portion of the object is to be depicted within a 3D environment. For example, selecting a rendering approach based on a distance between the viewer and the persona, and prior to switching to the different LOD representation. In some implementations, during the merging of the (second) subset of splats in the transition zone, a number of rendered splats is reduced as a distance associated with the position at which the at least the portion of the object is to be depicted increases. For example, prior to the switching to the lower LOD representation, gradually reducing (or increasing) the number of splats. In some implementations, the merging of the (second) subset of splats is performed in groups, with each group corresponding to a range of distances associated with the position at which the at least the portion of the object is to be depicted. For example, as illustrated in FIGS. 8 and 9, the transition between LODs may be gradually performed without abrupt changes in the number of splats rendered.

In some implementations, for the transition merging, intermediate LOD states may be utilized (e.g., a combination of LOD-0 and LOD-1). For example, the exact proportion of each LOD state varies with distance, more LOD-0 closer to the camera, and more LOD-1 further away from the camera. The runtime algorithm producing the LOD states operates by merging splats into bigger splats. In some implementations, this algorithm does not necessarily need to output a fixed number of merged splats, but can stochastically choose a variable number of splats to merge, and this variable number can be controlled by knobs, such as distance or angle to the camera.

In some implementations, the merging of splats may be based on determining whether a viewpoint characteristic satisfies a criterion, wherein the viewpoint characteristic is determined based on a viewpoint and a position at which the at least the portion of the object is to be depicted within a 3D environment. For example, as illustrated in FIG. 10A-10C, the techniques described herein may analyze a user's gaze direction, a field of view, a head pose, a 3D location of the rendered persona, and the like, to determine a viewpoint characteristic of a current view of a rendering of a virtual object, such as a persona. As illustrated in FIG. 10A-10C, a persona 1020 may be rendered at a higher level-of-detail (e.g., LOD-0 (˜64 k splats)), an intermediate level-of-detail (e.g., LOD-1 (˜32 k splats)), or a lower level-of-detail (e.g., LOD-2 (16 k splats or less)).

In some implementations, the criterion is based on a threshold angular distance from a gaze center. For example, the criterion may be based on the position of the persona relative to a field of view centerline (e.g., associated with gaze cone 1010). In some implementations, the criterion is based on a threshold distance associated with the position at which the at least the portion of the object is to be depicted within the 3D environment. For example, the criterion may be based on the position of the persona relative to a distance from the perception of the user—e.g., close to the periphery, but not enough to trigger the periphery/gaze cone angular threshold, but if persona is far off in the distance, could still trigger an adjusted LOD level and merging between LOD levels.

In some implementations, the merging of splats in peripheral regions is performed using a sparse UV mapping technique. For example, allowing for direct switching to a lower LOD in those regions.

In some implementations, the selection of splats to merge is based at least in part on a noise function. For example, the system may use noise functions to select which splats to merge, further reducing the perceptibility of LOD transitions.

In some implementations, a number of splats rendered for providing the view of the representation of the at least the portion of the object is (continuously) adjusted between a minimum and a maximum value as a function of at least one of: a distance associated with how the at least the portion of the object is to be depicted within the viewing experience, a gaze, or a field of view. For example, the system provides a dynamic, context-aware process for rendering 3D representations using 3D Gaussian splats, with advanced LOD transitioning based on distance, gaze, and/or field of view.

In various implementations, the selected splat rendering approach may be reused (e.g., rerendered) in subsequent frames if the characteristic (e.g., viewpoint) does not change. In some implementations, the view of the representation is provided for a first frame of a plurality of frames for a first viewpoint, the method 1100 further including, for a second viewpoint for a second frame of the plurality of frames determining that the second viewpoint is equivalent to the first viewpoint, and reusing the view of the representation of the at least the portion of the object from the first frame for the second frame (e.g., based on the selected splat approach form the first frame). Additionally, or alternatively, in some implementations, the view of the representation is provided for a first frame of a plurality of frames for a first viewpoint, the method 1100 further including, for a second viewpoint for a second frame of the plurality of frames determining that the second viewpoint is different than the first viewpoint, selecting a different splat rendering approach (i.e., improving or diminishing the quality of the rendering) based on a context of a viewing experience associated with the second frame (e.g., a viewer's perceived distance changes, another attribute of the context changes, etc.), and updating the view of the representation of the at least the portion of the object based on the different splat rendering approach.

In various implementations, the method 1100 further includes modifying the user representation data based on obtaining a set of sensor data obtained after an enrollment process. For example, modifying the splat parameter data based on live user data. For example, the splat parameter data may be obtained from a sending device such as from an enrollment process, and the modifications to the enrollment splat parameter data may be based on obtaining live sensor of the sender in order to determine a live representation of the sender (e.g., a live view of a realistic persona for a communication session). In some implementations, modifying the user representation data generates 3D Gaussian splats based on the image data for the at least the portion of the user, where the Gaussian splats include a texture, a position, and a splat shape. For example, a 3D Gaussian distribution in 2D space with color/density, e.g., parameterization where a face is represented as a grid, and the system determines a number or splats per ray off the face/grid. In some implementations, the splat generation technique generates a user representation via a machine learning model trained using training data obtained via one or more sensors in one or more environments. For example, a machine learning model that interprets the image data and/or other sensor data captured during enrollment.

In various implementations, the user representation data may be modified for a face and not the body, for a body and not the face, both the body and face, and/or may be modified either during an enrollment phase, on a sender side device and/or on a receiver side device. In other words, the user representation (persona) may be continuously updated to represent a live view of a current user's head/face and/or upper body movements and may be modified at different stages during a communication session. In some implementations, the splat rendering approach associated with the user representation data is modified based on body pose data obtained during the enrollment process, during a communication session with another device, or a combination thereof. In some implementations, the device is a viewer's device, and the splat rendering approach associated with the user representation data is modified based on an additional set of sensor data obtained during a communication session with a sender's device associated with the user representation. Alternatively, in some implementations, the splat rendering approach associated with the user representation data is generated and updated during the enrollment process based on images of a face of the user captured while the user is expressing a plurality of different facial expressions (e.g., enrollment images of the face while the user is smiling, brows raised, cheeks puffed out, etc.).

In some implementations, the second set of sensor data obtained after the enrollment process by the device (e.g., a viewer's device) includes a sequence of frames for a Gaussian UV Map and corresponding marker points. The sequence of frames for the Gaussian UV Map and corresponding marker points may be obtained during a communication session from a second device (e.g., a sender's device). The device (e.g., a viewer's device) renders an animated depiction of the user (e.g., a sender) based on the sequence of frames for a Gaussian UV Map and corresponding marker points using one or more splatting techniques described herein. For example, the set of Gaussian UV Map and corresponding marker points sent during a communication session with a second device may be used to render a view of the face (and upper body) of the user (sender). Additionally, or alternatively, sequential frames of face data (appearance of the user's face at different points in time) and body tracking data may be transmitted and used to display a live 3D video-like depiction of the user (e.g., a “live” persona).

In some implementations, the second user representation is based on second image data obtained via a second set of sensors in a second physical environment having a second lighting condition (e.g., different lighting condition than the first physical environment). For example, during an enrollment process, the user representation data is acquired in a particular environment (also referred to herein as an “enrollment environment”) that includes some lighting conditions information (e.g., luminance values and other lighting attributes), which may be different lighting data than live lighting data (e.g., two different physical environments between enrollment and during the generation of the persona based on “live” sensor data). In some implementations, providing the view of the representation of the at least the portion of the object based on the selected splat rendering approach includes displaying the representation in in a 3D environment, such as an extended reality (XR) environment.

In some implementations, the method 1100 further includes modifying the view of the user representation by adjusting the user representation based on at least one color attribute of a plurality of color attributes of an environment, at least one light attribute of a plurality of light attributes of the environment, or a combination thereof. For example, adjusting a color or lighting on the user representation, such as the hair, face, clothing, and the like, based on a color and/or light associated with the viewer's environment and/or with the sender's environment. In other words, the lighting and/or color of a 3D representation (e.g., persona) may be altered to match the lighting and/or color of a viewer's environment (e.g., a reddish hue of light shining in a viewer's room would be reflected on the 3D representation). Alternatively, the lighting and/or color of a 3D representation (e.g., persona) may be altered to match the lighting and/or color of a sender's environment (e.g., a greenish hue of light shining in a sender's room would be reflected on the 3D representation to a viewer, even though the enrollment data did not reflect the greenish hue of light).

In some implementations, the user representation data of at least a portion of a user that is obtained during an enrollment process is based on images of a face of the user captured in different poses, and/or while the user is expressing a plurality of different facial expressions. For example, the images are enrollment images of the face while the user is facing toward the camera, to the left of the camera, and to the right of the camera, and/or while the user is smiling, brows raised, cheeks puffed out, etc. For example, as illustrated by enrollment process 610 of FIG. 6, enrollment images 612 of the face may be obtained while the user is smiling, brows raised, cheeks puffed out, etc. from different viewpoints. In some implementations, the first set of sensor data corresponds to only a first area of the user (e.g., parts not obstructed by the device, such as an HMD), and the second set of sensor data corresponds to a second area including a third area different than the first area. For example, a second area may include some of the parts obstructed by an HMD when it is being worn by the user. For example, during an enrollment process, a larger portion of a user may be captured by image data (e.g., not wearing the HMD), than during a live communication session with the user wearing the HMD.

In some implementations, as illustrated in FIG. 2, the rendering occurs during a communication session in which a second device (e.g., device 265) captures sensor data (e.g., image data of user 260 and a portion of the environment 250) and provides a sequence of frame-specific 3D representations corresponding to the multiple instants in the period time based on the sensor data. For example, the second device 265 provides/transmits the sequence of frame-specific 3D representations to device 210, and device 210 generates the combined 3D representation to display a live 3D video-like face depiction (e.g., a realistic moving persona) of the user 260 (e.g., representation 240 of user 260). Alternatively, in some implementations, the second device provides the 3D representation of the user (e.g., representation 140 of user 260) during the communication session (e.g., a realistic moving persona). For example, the combined representation is determined at device 265 and sent to device 210. In some implementations, the views of the 3D representations are displayed on the device (e.g., device 210) in real-time relative to the multiple instants in the period of time. For example, the depiction of the user is displayed in real-time and based on live lighting data (e.g., a persona shown to a second user on a display of a second device of the second user).

In some implementations, the view of the user representation may include sufficient data to enable a stereo view of the user (e.g., left/right eye views) such that the face may be perceived with depth. In one implementation, a depiction of a face includes a 3D model of the face and views of the representation from a left eye position and a right eye position and are generated to provide a stereo view of the face.

In some implementations, certain parts of the face that may be of importance to conveying a realistic or honest appearance, such as the eyes and mouth, may be generated differently than other parts of the face (e.g., based on marker points). For example, parts of the face that may be of importance to conveying a realistic or honest appearance may be based on current camera data while other parts of the face may be based on previously-obtained (e.g., enrollment) face data.

In some implementations, a representation of a face is generated with texture, color, and/or geometry for various face portions identifying an estimate of how confident the generation technique is that such textures, colors, and/or geometries accurately correspond to the real texture, color, and/or geometry of those face portions based on the depth values and appearance values each frame of data. In some implementations, the depiction is a 3D persona. For example, the representation is a 3D model that represents the user (e.g., user 110 of FIG. 1).

In some implementations, the first set of sensor data and/or the second set of sensor data (e.g., live data, such as video content that includes light intensity data (RGB) and depth data), is associated with a point in time, such as images from inward/down facing sensors while the user is wearing an HMD associated with a frame. In some implementations, the sensor data includes depth data (e.g., infrared, time-of-flight, etc.) and light intensity image data obtained during a scanning process.

In some implementations, obtaining the first set of sensor data during an enrollment process may include obtaining enrollment sensor data corresponding to features (e.g., texture, muscle activation, shape, depth, etc.) of a face of a user in a plurality of configurations from a device (e.g., enrollment image data 612 of FIG. 6). In some implementations, the first set of data includes unobstructed image data of the face of the user. For example, images of the face may be captured while the user is smiling, brows raised, cheeks puffed out, etc. In some implementations, enrollment data may be obtained by a user taking the device (e.g., an HMD) off and capturing images without the device occluding the face or using another device (e.g., a mobile device) without the device (e.g., HMD) occluding the face. In some implementations, the enrollment data (e.g., the first set of data) is acquired from light intensity images (e.g., RGB image(s)). The enrollment data may include textures, muscle activations, etc., for most, if not all, of the user's face. In some implementations, the enrollment data may be captured while the user is provided different instructions to acquire different poses of the user's face. For example, the user may be instructed by a user interface guide to “raise your eyebrows,” “smile,” “frown,” etc., in order to provide the system with a range of facial features for an enrollment process.

In some implementations, the method 1100 may be repeated for each frame captured during each instant/frame of a live communication session or other experience. For example, for each iteration, while the user is using the device (e.g., wearing the HMD), the method 1100 may involve continuously obtaining live sensor data (e.g., face tracking data, body tracking, and the like), and for each frame, updating the selected subset of splat parameter data based on updated viewing characteristics (e.g., FoV, gaze, occlusions, etc.) for that frame, and update the displayed portions of the user representation based on the updated Gaussian data. For example, for each new frame, the system can update the display of the 3D persona based on the new data.

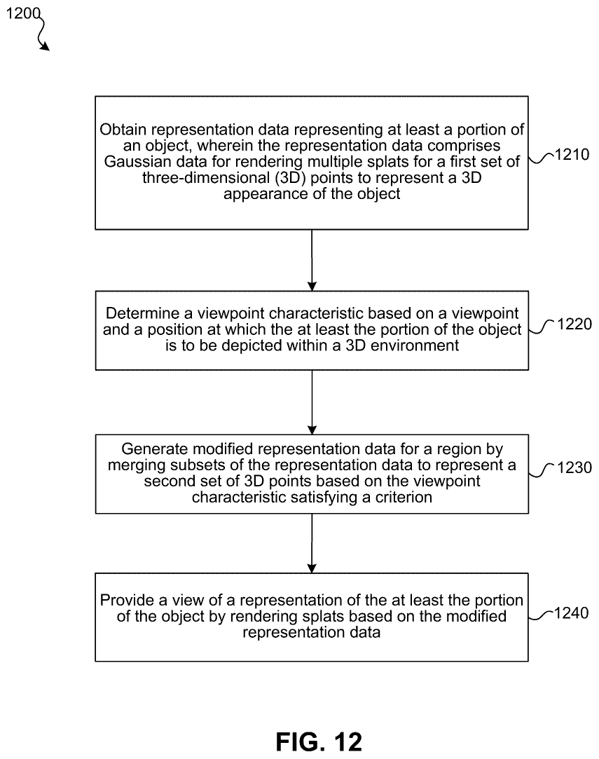

FIG. 12 is a flowchart illustrating an exemplary method 1200. In some implementations, a device (e.g., device 105 of FIG. 1) performs the techniques of method 1200 to provide a view of a representation by rendering splats based on merging subsets of representation data in accordance with some implementations. In some implementations, the techniques of method 1200 are performed on a mobile device, desktop, laptop, HMD, or server device. In some implementations, the method 1200 is performed on processing logic, including hardware, firmware, software, or a combination thereof. In some implementations, the method 1200 is performed on a processor executing code stored in a non-transitory computer-readable medium (e.g., a memory). In some implementations, the method 1200 is implemented at a processor of a device, such as a viewing device, that renders the user representation (e.g., device 210 of FIG. 2 renders 3D representation 240 of user 260 (a persona) from data obtained from device 265).

An exemplary implementation of method 1200, provides a dynamic, context-based selection and transitioning between LODs for 3DGS rendering, with a focus on minimizing perceptible transition artifacts and optimizing for both distance, gaze, and field of view. For example, method 1200 may provide a dynamic, context-aware rendering of 3D representations using Gaussian splats, with advanced LOD transitioning based on whether the persona is inside or outside of the user's field of view (e.g., foveal region or periphery), which may be determined based on the user's perspective, gaze, and/or the position of the persona relative to the field of view. The approach enables smooth, continuous LOD transitions, minimizes visual artifacts, and optimizes rendering efficiency and fidelity in regions of interest. For example, instead of abrupt LOD switches (e.g., from 64 k to 16 k splats), the system introduces a smooth, continuous reduction of splats. As the viewer moves away from the persona, splats are gradually merged, creating a transition zone that avoids noticeable “popping” effects. This merging may be tuned and may incorporate noise-based selection for further optimization. This approach minimizes visual artifacts during LOD changes, optimizes rendering efficiency, and maintains high visual fidelity in regions of interest.

At block 1210, the method 1200, at a processor of a device, obtains representation data representing at least a portion of an object, wherein the representation data includes Gaussian data for rendering multiple splats for a first set of 3D points to represent a 3D appearance of the object. For example, a splat generation technique (e.g., model/parameters specifying total number of splats, splat size attributes, etc.) may include generating multiple sets of splat parameter data (e.g., sets of splat parameter data ranging in different resolutions/sizes from 16 k splats to 64 k splats, or different LODs based on merged groupings of static splats, and the like). In some implementations, the representation data may be rendered using Gaussian splatting, which is a technique where individual 3D points are represented as Gaussian distributions (e.g., splat parameter data, also referred to as “splats”) with color values that change depending on the viewing angle, using spherical harmonics to model this view-dependent color variation and enables real-time rendering of high-quality, photorealistic scenes from a sparse set of images. For example, each point has a color that is calculated based on its position relative to the camera, allowing for realistic shading effects across different viewpoints.

At block 1220, the method 1200 determines a viewpoint characteristic based on a viewpoint and a position at which the at least the portion of the object is to be depicted within a 3D environment. For example, as illustrated in FIG. 10A-10C, the techniques described herein may analyze a user's gaze direction, a field of view, a head pose, a 3D location of the rendered persona, and the like, to determine a viewpoint characteristic of a current view of a rendering of a virtual object.

At block 1230, the method 1200 generates modified representation data for a region by merging subsets of the representation data to represent a second set of 3D points based on the viewpoint characteristic satisfying a criterion. The second set of 3D points may be fewer in number than the first set of 3D points. For example, dynamically merging splats in one or more transition zones LOD-1 to LOD-0, based on the distance, such that the number of rendered splats is continuously reduced as the distance increases, prior to switching to a lower LOD representation. For example, directing the merging of splats based on the gaze direction, such that regions within a threshold angle of the gaze center retain higher detail, and regions outside the threshold are merged more aggressively.

At block 1240, the method 1200 provides a view of a representation of the at least the portion of the object by rendering splats based on the modified representation data. As illustrated in FIG. 10A-10C, a persona 1020 may be rendered at a higher level-of-detail (e.g., LOD-0 (˜64 k splats)), an intermediate level-of-detail (e.g., LOD-1 (˜32 k splats)), or a lower level-of-detail (e.g., LOD-2 (16 k splats or less)), and while transitioning between different LODs, the system provides a view that merges subsets of the splats to minimize visual artifacts during LOD changes, optimize rendering efficiency, and maintain a high visual fidelity in regions of interest.

In some implementations, during the merging of the subsets of the representation data to represent a second set of 3D points, a number of rendered splats is reduced as a distance associated with the position at which the at least the portion of the object is to be depicted increases. For example, prior to the switching to the lower LOD representation, gradually reducing (or increasing) the number of splats. In some implementations, the merging of the subsets of the representation data to represent a second set of 3D points is performed in groups, with each group corresponding to a range of distances associated with the position at which the at least the portion of the object is to be depicted. For example, as illustrated in FIGS. 8 and 9, the transition between LODs may be gradually performed without abrupt changes in the number of splats rendered.

In some implementations, for the transition merging, intermediate LOD states may be utilized (e.g., a combination of LOD-0 and LOD-1). For example, the exact proportion of each LOD state varies with distance, more LOD-0 closer to the camera, and more LOD-1 further away from the camera. The runtime algorithm producing the LOD states operates by merging splats into bigger splats. In some implementations, this algorithm does not necessarily need to output a fixed number of merged splats, but can stochastically choose a variable number of splats to merge, and this variable number can be controlled by knobs, such as distance or angle to the camera.

In some implementations, the merging of the subsets of the representation data to represent a second set of 3D points is based on determining whether the viewpoint characteristic satisfies the criterion, and the viewpoint characteristic is determined based on the viewpoint and the position at which the at least the portion of the object is to be depicted within a 3D environment. For example, as illustrated in FIG. 10A-10C, the techniques described herein may analyze a user's gaze direction, a field of view, a head pose, a 3D location of the rendered persona, and the like, to determine a viewpoint characteristic of a current view of a rendering of a virtual object, such as a persona. As illustrated in FIG. 10A-10C, a persona 1020 may be rendered at a higher level-of-detail (e.g., LOD-0 (˜64 k splats)), an intermediate level-of-detail (e.g., LOD-1 (˜32 k splats)), or a lower level-of-detail (e.g., LOD-2 (16 k splats or less)).

In some implementations, the criterion is based on a threshold angular distance from a gaze center. For example, the criterion may be based on the position of the persona relative to a field of view centerline (e.g., associated with gaze cone 1010). In some implementations, the criterion is based on a threshold distance associated with the position at which the at least the portion of the object is to be depicted within the 3D environment. For example, the criterion may be based on the position of the persona relative to a distance from the perception of the user—e.g., close to the periphery, but not enough to trigger the periphery/gaze cone angular threshold, but if persona is far off in the distance, could still trigger an adjusted LOD level and merging between LOD levels.

In some implementations, the merging of splats in peripheral regions is performed using a sparse UV mapping technique. For example, allowing for direct switching to a lower LOD in those regions. In some implementations, the selection of splats to merge is based at least in part on a noise function. For example, the system may use noise functions to select which splats to merge, further reducing the perceptibility of LOD transitions.

In some implementations, a number of splats rendered for providing the view of the representation of the at least the portion of the object is (continuously) adjusted between a minimum and a maximum value as a function of at least one of: a distance associated with how the at least the portion of the object is to be depicted within the viewing experience, a gaze, or a field of view. For example, the system provides a dynamic, context-aware process for rendering 3D representations using 3D Gaussian splats, with advanced LOD transitioning based on distance, gaze, and/or field of view.

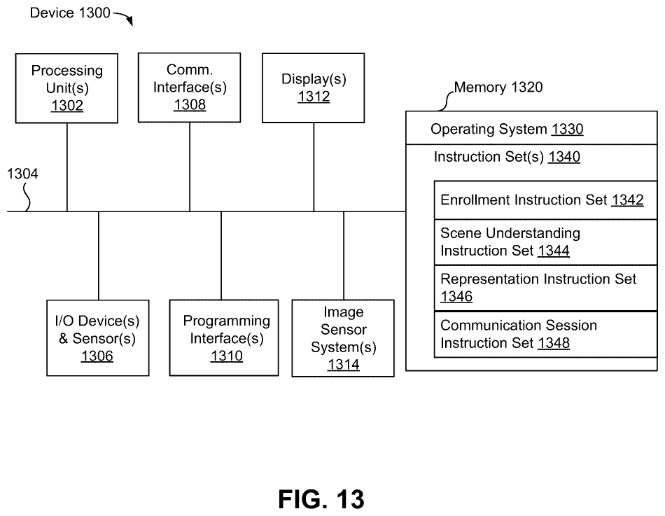

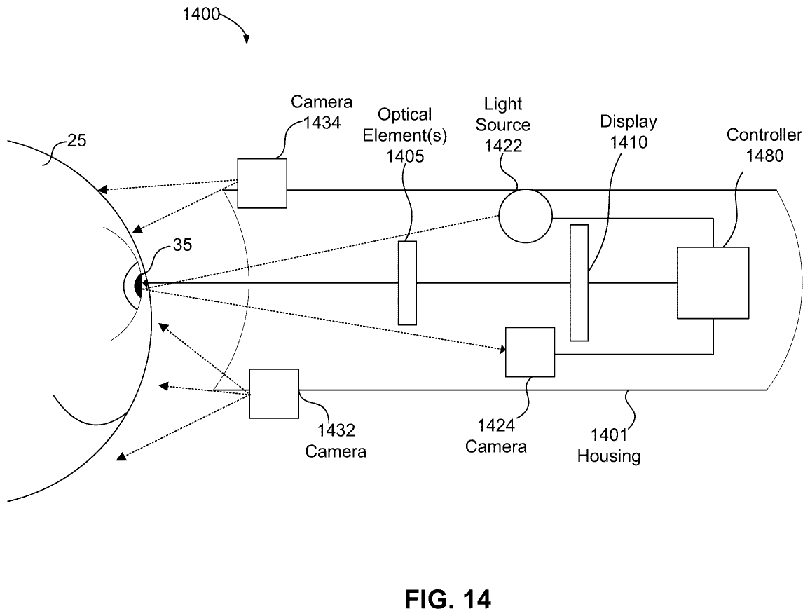

FIG. 13 is a block diagram of an example device 1300. Device 1300 illustrates an exemplary device configuration for devices described herein (e.g., devices 105, 210, 265, 745, etc.). While certain specific features are illustrated, those skilled in the art will appreciate from the present disclosure that various other features have not been illustrated for the sake of brevity, and so as not to obscure more pertinent aspects of the implementations disclosed herein. To that end, as a non-limiting example, in some implementations the device 1300 includes one or more processing units 1302 (e.g., microprocessors, ASICs, FPGAs, GPUs, CPUs, processing cores, and/or the like), one or more input/output (I/O) devices and sensors 1306, one or more communication interfaces 1308 (e.g., USB, FIREWIRE, THUNDERBOLT, IEEE 802.3x, IEEE 802.11x, IEEE 802.16x, GSM, CDMA, TDMA, GPS, IR, BLUETOOTH, ZIGBEE, SPI, I2C, and/or the like type interface), one or more programming (e.g., I/O) interfaces 1310, one or more displays 1312, one or more interior and/or exterior facing image sensor systems 1314, a memory 1320, and one or more communication buses 1304 for interconnecting these and various other components.

In some implementations, the one or more communication buses 1304 include circuitry that interconnects and controls communications between system components. In some implementations, the one or more I/O devices and sensors 1306 include at least one of an inertial measurement unit (IMU), an accelerometer, a magnetometer, a gyroscope, a thermometer, one or more physiological sensors (e.g., blood pressure monitor, heart rate monitor, blood oxygen sensor, blood glucose sensor, etc.), one or more microphones, one or more speakers, a haptics engine, one or more depth sensors (e.g., a structured light, a time-of-flight, or the like), and/or the like.

In some implementations, the one or more displays 1312 are configured to present a view of a physical environment or a graphical environment to the user. In some implementations, the one or more displays 1312 correspond to holographic, digital light processing (DLP), liquid-crystal display (LCD), liquid-crystal on silicon (LCoS), organic light-emitting field-effect transitory (OLET), organic light-emitting diode (OLED), surface-conduction electron-emitter display (SED), field-emission display (FED), quantum-dot light-emitting diode (QD-LED), micro-electromechanical system (MEMS), and/or the like display types. In some implementations, the one or more displays 1312 correspond to diffractive, reflective, polarized, holographic, etc. waveguide displays. In one example, the device 1300 includes a single display. In another example, the device 1300 includes a display for each eye of the user.

In some implementations, the one or more image sensor systems 1314 are configured to obtain image data that corresponds to at least a portion of the physical environment 102. For example, the one or more image sensor systems 1314 include one or more RGB cameras (e.g., with a complimentary metal-oxide-semiconductor (CMOS) image sensor or a charge-coupled device (CCD) image sensor), monochrome cameras, IR cameras, depth cameras, event-based cameras, and/or the like. In various implementations, the one or more image sensor systems 1314 further include illumination sources that emit light, such as a flash. In various implementations, the one or more image sensor systems 1314 further include an on-camera image signal processor (ISP) configured to execute a plurality of processing operations on the image data.

The memory 1320 includes high-speed random-access memory, such as DRAM, SRAM, DDR RAM, or other random-access solid-state memory devices. In some implementations, the memory 1320 includes non-volatile memory, such as one or more magnetic disk storage devices, optical disk storage devices, flash memory devices, or other non-volatile solid-state storage devices. The memory 1320 optionally includes one or more storage devices remotely located from the one or more processing units 1302. The memory 1320 includes a non-transitory computer readable storage medium.

In some implementations, the memory 1320 or the non-transitory computer readable storage medium of the memory 1320 stores an optional operating system 1330 and one or more instruction set(s) 1340. The operating system 1330 includes procedures for handling various basic system services and for performing hardware dependent tasks. In some implementations, the instruction set(s) 1340 include executable software defined by binary information stored in the form of electrical charge. In some implementations, the instruction set(s) 1340 are software that is executable by the one or more processing units 1302 to carry out one or more of the techniques described herein.

The instruction set(s) 1340 include an enrollment instruction set 1342, scene understanding instruction set 1344, a representation instruction set 1346, and a communication session instruction set 1348. The instruction set(s) 1340 may be embodied a single software executable or multiple software executables.

In some implementations, the enrollment instruction set 1342 is executable by the processing unit(s) 1302 to generate enrollment data from image data. The enrollment instruction set 1342 may be configured to provide instructions to the user in order to acquire image information to generate the enrollment personification (e.g., enrollment image data 612) and determine whether additional image information is needed to generate an accurate enrollment personification to be used by the persona display process. To these ends, in various implementations, the instruction includes instructions and/or logic therefor, and heuristics and metadata therefor.

In some implementations, the scene understanding instruction set 1344 is executable by the processing unit(s) 1302 to determine a context of the experience and/or the environment or a context of the user viewing an environment (e.g., a user understanding). The scene understanding instruction set 1344 may create a scene understanding to determine the objects or people in the content or in the environment, where the user is, what the user is watching, etc., using one or more of the techniques discussed herein (e.g., object detection, facial recognition, etc.) or as otherwise may be appropriate. To these ends, in various implementations, the instruction includes instructions and/or logic therefor, and heuristics and metadata therefor.

In some implementations, the representation instruction set 1346 is executable by the processing unit(s) 1302 to generate a representation of an object such as a user representation (e.g., rendering via a Gaussian splatting technique) by using one or more of the techniques discussed herein or as otherwise may be appropriate. In some implementations, the representation instruction set 1346 is executable by the processing unit(s) 1302 to analyze and select a splat rendering approach (e.g., a rendering mode) for use in providing a view that includes a representation based on a determined context of the viewing experience as discussed herein or as otherwise may be appropriate. To these ends, in various implementations, the instruction includes instructions and/or logic therefor, and heuristics and metadata therefor.

In some implementations, the communication session instruction set 1348 is executable by the processing unit(s) 1302 to facilitate a communication session between two or more electronic devices (e.g., device 210 and device 265 as illustrated in FIG. 2) using one or more of the techniques discussed herein or as otherwise may be appropriate. To these ends, in various implementations, the instruction includes instructions and/or logic therefor, and heuristics and metadata therefor.

Although the instruction set(s) 1340 are shown as residing on a single device, it should be understood that in other implementations, any combination of the elements may be located in separate computing devices. Moreover, FIG. 13 is intended more as functional description of the various features which are present in a particular implementation as opposed to a structural schematic of the implementations described herein. As recognized by those of ordinary skill in the art, items shown separately could be combined and some items could be separated. The actual number of instructions sets and how features are allocated among them may vary from one implementation to another and may depend in part on the particular combination of hardware, software, and/or firmware chosen for a particular implementation.

FIG. 13 illustrates a block diagram of an exemplary head-mounted device 1300 in accordance with some implementations. The head-mounted device 1300 includes a housing 1301 (or enclosure) that houses various components of the head-mounted device 1300. The housing 1301 includes (or is coupled to) an eye pad (not shown) disposed at a proximal (to the user 25) end of the housing 1301. In various implementations, the eye pad is a plastic or rubber piece that comfortably and snugly keeps the head-mounted device 1300 in the proper position on the face of the user 25 (e.g., surrounding the eye 35 of the user 25).

The housing 1301 houses a display 1310 that displays an image, emitting light towards or onto the eye of a user 25. In various implementations, the display 1310 emits the light through an eyepiece having one or more optical elements 1305 that refracts the light emitted by the display 1310, making the display appear to the user 25 to be at a virtual distance farther than the actual distance from the eye to the display 1310. For example, optical element(s) 1305 may include one or more lenses, a waveguide, other diffraction optical elements (DOE), and the like. For the user 25 to be able to focus on the display 1310, in various implementations, the virtual distance is at least greater than a minimum focal distance of the eye (e.g., 7 cm). Further, in order to provide a better user experience, in various implementations, the virtual distance is greater than 1 meter.

The housing 1301 also houses a tracking system including one or more light sources 1322, camera 1324, camera 1332, camera 1334, and a controller 1380. The one or more light sources 1322 emit light onto the eye of the user 25 that reflects as a light pattern (e.g., a circle of glints) that can be detected by the camera 1324. Based on the light pattern, the controller 1380 can determine an eye tracking characteristic of the user 25. For example, the controller 1380 can determine a gaze direction and/or a blinking state (eyes open or eyes closed) of the user 25. As another example, the controller 1380 can determine a pupil center, a pupil size, or a point of regard. Thus, in various implementations, the light is emitted by the one or more light sources 1322, reflects off the eye of the user 25, and is detected by the camera 1324. In various implementations, the light from the eye of the user 25 is reflected off a hot mirror or passed through an eyepiece before reaching the camera 1324.

The display 1310 emits light in a first wavelength range and the one or more light sources 1322 emit light in a second wavelength range. Similarly, the camera 1324 detects light in the second wavelength range. In various implementations, the first wavelength range is a visible wavelength range (e.g., a wavelength range within the visible spectrum of approximately 400-700 nm) and the second wavelength range is a near-infrared wavelength range (e.g., a wavelength range within the near-infrared spectrum of approximately 700-1400 nm).

In various implementations, eye tracking (or, in particular, a determined gaze direction) is used to enable user interaction (e.g., the user 25 selects an option on the display 1310 by looking at it), provide foveated rendering (e.g., present a higher resolution in an area of the display 1310 the user 25 is looking at and a lower resolution elsewhere on the display 1310), or correct distortions (e.g., for images to be provided on the display 1310). In various implementations, the one or more light sources 1322 emit light towards the eye 35 of the user 25 which reflects in the form of a plurality of glints.

In various implementations, the camera 1324 is a frame/shutter-based camera that, at a particular point in time or multiple points in time at a frame rate, generates an image of the eye 35 of the user 25. Each image includes a matrix of pixel values corresponding to pixels of the image which correspond to locations of a matrix of light sensors of the camera. In implementations, each image is used to measure or track pupil dilation by measuring a change of the pixel intensities associated with one or both of a user's pupils.

In various implementations, the camera 1324 is an event camera including a plurality of light sensors (e.g., a matrix of light sensors) at a plurality of respective locations that, in response to a particular light sensor detecting a change in intensity of light, generates an event message indicating a particular location of the particular light sensor.

In various implementations, the camera 1332 and camera 1334 are frame/shutter-based cameras that, at a particular point in time or multiple points in time at a frame rate, can generate an image of the face of the user 25. For example, camera 1332 captures images of the user's face below the eyes, and camera 1334 captures images of the user's face above the eyes. The images captured by camera 1332 and camera 1334 may include light intensity images (e.g., RGB) and/or depth image data (e.g., Time-of-Flight, infrared, etc.).

It will be appreciated that the implementations described above are cited by way of example, and that the present invention is not limited to what has been particularly shown and described hereinabove. Rather, the scope includes both combinations and sub combinations of the various features described hereinabove, as well as variations and modifications thereof which would occur to persons skilled in the art upon reading the foregoing description and which are not disclosed in the prior art.

As described above, one aspect of the present technology is the gathering and use of physiological data to improve a user's experience of an electronic device with respect to interacting with electronic content. The present disclosure contemplates that in some instances, this gathered data may include personal information data that uniquely identifies a specific person or can be used to identify interests, traits, or tendencies of a specific person. Such personal information data can include physiological data, demographic data, location-based data, telephone numbers, email addresses, home addresses, device characteristics of personal devices, or any other personal information.

The present disclosure recognizes that the use of such personal information data, in the present technology, can be used to the benefit of users. For example, the personal information data can be used to improve interaction and control capabilities of an electronic device. Accordingly, use of such personal information data enables calculated control of the electronic device. Further, other uses for personal information data that benefit the user are also contemplated by the present disclosure.

The present disclosure further contemplates that the entities responsible for the collection, analysis, disclosure, transfer, storage, or other use of such personal information and/or physiological data will comply with well-established privacy policies and/or privacy practices. In particular, such entities should implement and consistently use privacy policies and practices that are generally recognized as meeting or exceeding industry or governmental requirements for maintaining personal information data private and secure. For example, personal information from users should be collected for legitimate and reasonable uses of the entity and not shared or sold outside of those legitimate uses. Further, such collection should occur only after receiving the informed consent of the users. Additionally, such entities would take any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices.

Despite the foregoing, the present disclosure also contemplates implementations in which users selectively block the use of, or access to, personal information data. That is, the present disclosure contemplates that hardware or software elements can be provided to prevent or block access to such personal information data. For example, in the case of user-tailored content delivery services, the present technology can be configured to allow users to select to “opt in” or “opt out” of participation in the collection of personal information data during registration for services. In another example, users can select not to provide personal information data for targeted content delivery services. In yet another example, users can select to not provide personal information, but permit the transfer of anonymous information for the purpose of improving the functioning of the device.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, content can be selected and delivered to users by inferring preferences or settings based on non-personal information data or a bare minimum amount of personal information, such as the content being requested by the device associated with a user, other non-personal information available to the content delivery services, or publicly available information.

In some embodiments, data is stored using a public/private key system that only allows the owner of the data to decrypt the stored data. In some other implementations, the data may be stored anonymously (e.g., without identifying and/or personal information about the user, such as a legal name, username, time and location data, or the like). In this way, other users, hackers, or third parties cannot determine the identity of the user associated with the stored data. In some implementations, a user may access his or her stored data from a user device that is different than the one used to upload the stored data. In these instances, the user may be required to provide login credentials to access their stored data.

Numerous specific details are set forth herein to provide a thorough understanding of the claimed subject matter. However, those skilled in the art will understand that the claimed subject matter may be practiced without these specific details. In other instances, methods, apparatuses, or systems that would be known by one of ordinary skill have not been described in detail so as not to obscure claimed subject matter.

Unless specifically stated otherwise, it is appreciated that throughout this specification discussions utilizing the terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform.

The system or systems discussed herein are not limited to any particular hardware architecture or configuration. A computing device can include any suitable arrangement of components that provides a result conditioned on one or more inputs. Suitable computing devices include multipurpose microprocessor-based computer systems accessing stored software that programs or configures the computing system from a general purpose computing apparatus to a specialized computing apparatus implementing one or more implementations of the present subject matter. Any suitable programming, scripting, or other type of language or combinations of languages may be used to implement the teachings contained herein in software to be used in programming or configuring a computing device.

Implementations of the methods disclosed herein may be performed in the operation of such computing devices. The order of the blocks presented in the examples above can be varied for example, blocks can be re-ordered, combined, or broken into sub-blocks. Certain blocks or processes can be performed in parallel.

The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or value beyond those recited. Headings, lists, and numbering included herein are for ease of explanation only and are not meant to be limiting.

It will also be understood that, although the terms “first,” “second,” etc. may be used herein to describe various objects, these objects should not be limited by these terms. These terms are only used to distinguish one object from another. For example, a first node could be termed a second node, and, similarly, a second node could be termed a first node, which changing the meaning of the description, so long as all occurrences of the “first node” are renamed consistently and all occurrences of the “second node” are renamed consistently. The first node and the second node are both nodes, but they are not the same node.

The terminology used herein is for the purpose of describing particular implementations only and is not intended to be limiting of the claims. As used in the description of the implementations and the appended claims, the singular forms “a,” “an,” and “the” are intended to include the plural forms as well, unless the context clearly indicates otherwise. It will also be understood that the term “or” as used herein refers to and encompasses any and all possible combinations of one or more of the associated listed items. It will be further understood that the terms “comprises” or “comprising,” when used in this specification, specify the presence of stated features, integers, steps, operations, objects, or components, but do not preclude the presence or addition of one or more other features, integers, steps, operations, objects, components, or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

The foregoing description and summary of the invention are to be understood as being in every respect illustrative and exemplary, but not restrictive, and the scope of the invention disclosed herein is not to be determined only from the detailed description of illustrative implementations but according to the full breadth permitted by patent laws.

It is to be understood that the implementations shown and described herein are only illustrative of the principles of the present invention and that various modification may be implemented by those skilled in the art without departing from the scope and spirit of the invention.

What is claimed is:

1. A method comprising:
at a processor of a device:
obtaining representation data representing at least a portion of an object, wherein the representation data comprises data for multiple sets of splats generated based on a splat generation technique, the data for each set of the multiple sets of splats comprising three-dimensional (3D) Gaussian data;
determining a context of a viewing experience;
selecting a splat rendering approach for use in providing a view that comprises a representation of the at least the portion of the object based on the determined context of the viewing experience; and
providing a view of a representation of the at least the portion of the object based on the selected splat rendering approach, wherein providing the view comprises rendering a subset of splats based on the 3D Gaussian data.

2. The method of claim 1, wherein the at least the portion of the object comprises a face portion and an additional portion of a user.

3. The method of claim 1, wherein the splat generation technique comprises a splat criterion associated with at least one of: (i) a resolution of each splat associated with each of the multiple sets of splats, (ii) a quantity of splats associated with each of the multiple sets of splats, and (iii) a size of each splat associated with each of the multiple sets of splats.

4. The method of claim 1, wherein selecting the splat rendering approach comprises selecting between a first approach that renders a first set of the multiple sets of splats and a second approach that renders a second set of the multiple sets of splats, wherein the first set of multiple sets of splats has more splats than the second set of the multiple sets of splats.

5. The method of claim 1, wherein the splat generation technique comprises a splat criterion associated with merging a plurality of subsets of splats based on the 3D Gaussian data.

6. The method of claim 5, wherein the plurality of subsets of splats are selected based on determining one or more static regions associated with representing the at least the portion of the object.

7. The method of claim 1, wherein selecting the splat rendering approach comprises:
selecting an approach that reduced a level of rendering detail by switching to rendering a lower level-of-detail (LOD) representation, rendering the lower LOD representation comprising merging a subset of splats in a transition zone based on a position at which the at least the portion of the object is to be depicted within a 3D environment.

8. The method of claim 7, wherein, during the merging of the subset of splats in the transition zone, a number of rendered splats is reduced as a distance associated with the position at which the at least the portion of the object is to be depicted increases.

9. The method of claim 7, wherein the merging of the subset of splats is performed in groups, with each group corresponding to a range of distances associated with the position at which the at least the portion of the object is to be depicted.

10. The method of claim 7, wherein the merging of splats is based on determining whether a viewpoint characteristic satisfies a criterion, wherein the viewpoint characteristic is determined based on a viewpoint and a position at which the at least the portion of the object is to be depicted within a 3D environment.

11. The method of claim 10, wherein the criterion is based on a threshold angular distance from a gaze direction.

12. The method of claim 10, wherein the criterion is based on a threshold distance associated with the position at which the at least the portion of the object is to be depicted within the 3D environment.

13. The method of claim 7, wherein the merging of splats in peripheral regions is performed using a sparse UV mapping technique.

14. The method of claim 7, wherein the selection of splats to merge is based at least in part on a noise function.

15. The method of claim 1, wherein a number of splats rendered for providing the view of the representation of the at least the portion of the object is adjusted between a minimum and a maximum value as a function of at least one of: a distance associated with how the at least the portion of the object is to be depicted within the viewing experience, a gaze, or a field of view.

16. The method of claim 1, wherein the context of the viewing experience comprises a viewpoint of the view of the representation and selecting the splat rendering approach for use in providing a view is based on a threshold distance associated with the viewpoint.

17. The method of claim 1, wherein the context of the viewing experience comprises recording of at least one frame of content associated with a viewpoint of the view of the representation and selecting the splat rendering approach for use in providing a view is based on the recording of the at least one frame of content.

18. The method of claim 1, wherein the view of the representation is provided for a first frame of a plurality of frames for a first viewpoint, the method further comprising, for a second viewpoint for a second frame of the plurality of frames:
in response to determining that the second viewpoint is equivalent to the first viewpoint, reusing the view of the representation of the at least the portion of the object from the first frame for the second frame; and
in response to determining that the second viewpoint is different than the first viewpoint,
selecting an additional set of the multiple sets of splats based on a context of a viewing experience associated with the second frame, and
updating the view of the representation of the at least the portion of the object based on the selected additional set of the multiple sets of splats.

19. A device comprising:
a non-transitory computer-readable storage medium; and
one or more processors coupled to the non-transitory computer-readable storage medium, wherein the non-transitory computer-readable storage medium comprises program instructions that, when executed on the one or more processors, cause the one or more processors to perform operations comprising:
obtaining representation data representing at least a portion of an object, wherein the representation data comprises data for multiple sets of splats generated based on a splat generation technique, the data for each set of the multiple sets of splats comprising three-dimensional (3D) Gaussian data;
determining a context of a viewing experience;
selecting a splat rendering approach for use in providing a view that comprises a representation of the at least the portion of the object based on the determined context of the viewing experience; and
providing a view of a representation of the at least the portion of the object based on the selected splat rendering approach, wherein providing the view comprises rendering a subset of splats based on the 3D Gaussian data.

20. A non-transitory computer-readable storage medium, storing program instructions executable on a device to perform operations comprising:
obtaining representation data representing at least a portion of an object, wherein the representation data comprises data for multiple sets of splats generated based on a splat generation technique, the data for each set of the multiple sets of splats comprising three-dimensional (3D) Gaussian data;
determining a context of a viewing experience;
selecting a splat rendering approach for use in providing a view that comprises a representation of the at least the portion of the object based on the determined context of the viewing experience; and
providing a view of a representation of the at least the portion of the object based on the selected splat rendering approach, wherein providing the view comprises rendering a subset of splats based on the 3D Gaussian data.
